(19) United States
(12) Patent Application Publication
(10) Pub. No.: US 2016/0057679 A1
(43) Pub. Date: Feb. 25, 2016

(54) CSON-AIDED SMALL CELL LOAD BALANCING BASED ON BACKHAUL INFORMATION

(71) Applicant: QUALCOMM Incorporated, San Diego, CA (US)

(72) Inventors: Marc Walter WERNER, Heroldsberg (DE); Patrick STUPAR, Nuremberg (DE); Andrea GARAVAGLIA, Nuremberg (DE); Sumeeth NAGARAJA, San Diego, CA (US); Andrei Dragos RADULESCU, San Diego, CA (US)

(21) Appl. No.: 14/705,826

(22) Filed: May 6, 2015

Related U.S. Application Data
(60) Provisional application No. 62/040,517, filed on Aug. 22, 2014.

(51) Int. Cl. H04W 36/22; H04W 28/08; H04W 52/04; H04W 36/08

(52) U.S. Cl. CPC H04W 36/22; H04W 36/08; H04W 28/08; H04W 52/04; H04W 84/18

(57) ABSTRACT

Methods and systems are disclosed for centralized self-organizing network (cSON)-aided small cell load balancing based on backhaul information. In an aspect, a cSON server receives periodic or event triggered backhaul capacity reports from each of the plurality of small cell base stations, a backhaul capacity report indicating an uplink and/or downlink capacity state of a backhaul connection over which a small cell base station of the plurality of small cell base stations is connected to a core network, determines load balancing assistance data for at least one of the plurality of small cell base stations based on the backhaul capacity reports received from each of the plurality of small cell base stations, and provides the load balancing assistance data to the at least one of the plurality of small cell base stations.

### CROSS-REFERENCE TO RELATED APPLICATIONS

The present application for patent claims the benefit of U.S. Provisional Application No. 62/040,517, entitled “CSON-AIDED SMALL CELL LOAD BALANCING BASED ON BACKHAUL INFORMATION,” filed Aug. 22, 2014, assigned to the assignee hereof, and expressly incorporated herein by reference in its entirety.

### INTRODUCTION

Aspects of this disclosure relate generally to telecommunications, and more particularly to centralized self-organizing network (cSON)-aided small cell load balancing based on backhaul information.

Wireless communication systems are widely deployed to provide various types of communication content, such as voice, data, multimedia, and so on. Typical wireless communication systems are multiple-access systems capable of supporting communication with multiple users by sharing available system resources (e.g., bandwidth, transmit power, etc.). Examples of such multiple-access systems include Code Division Multiple Access (CDMA) systems, Time Division Multiple Access (TDMA) systems, Frequency Division Multiple Access (FDMA) systems, Orthogonal Frequency Division Multiple Access (OFDMA) systems, and others. These systems are often deployed in conformity with specifications such as Third Generation Partnership Project (3GPP), 3GPP Long Term Evolution (LTE), Ultra Mobile Broadband (UMB), Evolution Data Optimized (EV-DO), Institute of Electrical and Electronics Engineers (IEEE), etc.

In cellular networks, “macro cell” base stations provide connectivity and coverage to a large number of users over a certain geographical area. A macro network deployment is carefully planned, designed, and implemented to offer good coverage over the geographical region. Even such careful planning, however, cannot fully accommodate channel characteristics such as fading, multipath, shadowing, etc., especially in indoor environments.

To improve indoor or other specific geographic coverage, such as for residential homes and office buildings, additional “small cell,” typically low-power, base stations have recently begun to be deployed to supplement conventional macro networks. Small cell base stations (also referred to simply as “small cells”) may also provide incremental capacity growth, richer user experience, and so on.

Small cell base stations may be connected to the core network, or backbone network, using any of a multitude of devices or methods. These connections may be referred to as the “backbone” or the “backhaul” of the network. However, the backhaul may impose various limitations in a dense neighborhood small cells (NSC) deployment. NSCs are typically deployed in private homes with limited backhaul capacity, for example, where the home is connected to the core network via consumer DSL, cable, etc. This limited backhaul capacity can be especially noticeable on the uplink. Further, there may be large traffic variations in NSC networks.

While LTE was designed to appropriately address radio-related capacity variations and limitations, the issue of local backhaul limitations also needs to be addressed by self-organizing network (SON) functions located at each NSC (i.e., distributed SON or “dSON”) and/or at a centralized location (i.e., centralized SON or “cSON”). These functions can effectively provide backhaul-related load balancing through different adaptations in the radio network.

### SUMMARY

The following presents a simplified summary relating to one or more aspects and/or embodiments associated with the mechanisms disclosed herein for cSON-aided small cell load balancing based on backhaul information. As such, the following summary should not be considered an extensive overview relating to all contemplated aspects and/or embodiments, nor should the following summary be regarded to identify key or critical elements relating to all contemplated aspects and/or embodiments or to delineate the scope associated with any particular aspect and/or embodiment. Accordingly, the following summary has the sole purpose to present certain concepts relating to one or more aspects and/or embodiments relating to the mechanisms disclosed herein in a simplified form to precede the detailed description presented below.

A method of a cSON server providing load balancing assistance to a plurality of small cell base stations load balancing includes receiving periodic or event triggered backhaul capacity reports from each of the plurality of small cell base stations, a backhaul capacity report indicating an uplink and/or downlink capacity state of a backhaul connection over which a small cell base station of the plurality of small cell base stations is connected to a core network, determining load balancing assistance data for at least one of the plurality of small cell base stations based on the backhaul capacity reports received from each of the plurality of small cell base stations, wherein the load balancing assistance data comprises an adaption of a backhaul uplink rate limit of the at least one small cell base station, and providing the load balancing assistance data to the at least one of the plurality of small cell base stations.

An apparatus for a cSON server providing load balancing assistance to a plurality of small cell base stations includes a transceiver configured to receive periodic or event-triggered backhaul capacity reports from each of the plurality of small cell base stations, a backhaul capacity report indicating an uplink and/or downlink capacity state of a backhaul connection over which a small cell base station of the plurality of small cell base stations is connected to a core network, and a processor configured to determine load balancing assistance data for at least one of the plurality of small cell base stations based on the backhaul capacity reports received from each of the plurality of small cell base stations, wherein the load balancing assistance data comprises an adaption of a backhaul uplink rate limit of the at least one small cell base station, wherein the transceiver is further configured to provide the load balancing assistance data to the at least one of the plurality of small cell base stations.

An apparatus for a cSON server providing load balancing assistance to a plurality of small cell base stations includes means for receiving periodic or event-triggered backhaul capacity reports from each of the plurality of small cell base stations, a backhaul capacity report indicating an uplink and/or downlink capacity state of a backhaul connection over which a small cell base station of the plurality of small cell base stations is connected to a core network, means for determining load balancing assistance data for at least one of the plurality of small cell base stations based on the backhaul capacity reports received from each of the plurality of small cell base stations, wherein the load balancing assistance data comprises an adaption of a backhaul uplink rate limit of the at least one small cell base station, and means for providing the load balancing assistance data to the at least one of the plurality of small cell base stations.

A non-transitory computer-readable medium of a cSON server providing load balancing assistance to a plurality of small cell base stations includes at least one instruction to receive periodic or event-triggered backhaul capacity reports from each of the plurality of small cell base stations, a backhaul capacity report indicating an uplink and/or downlink capacity state of a backhaul connection over which a small cell base station of the plurality of small cell base stations is connected to a core network, at least one instruction to determine load balancing assistance data for at least one of the plurality of small cell base stations based on the backhaul capacity reports received from each of the plurality of small cell base stations, wherein the load balancing assistance data comprises an adaption of a backhaul uplink rate limit of the at least one small cell base station, and at least one instruction to provide the load balancing assistance data to the at least one of the plurality of small cell base stations.

Other objects and advantages associated with the mechanisms disclosed herein will be apparent to those skilled in the art based on the accompanying drawings and detailed description.

### BRIEF DESCRIPTION OF THE DRAWINGS

The accompanying drawings are presented to aid in the description of various aspects of the disclosure and are provided solely for illustration of the aspects and not limitation thereof.

FIG. 1 illustrates an example mixed-deployment wireless communication system including macro cell base stations and small cell base stations.

FIG. 2 illustrates another example mixed communication system.

FIG. 3 illustrates an exemplary hardware architecture of a small cell base station with co-located radio components.

FIG. 4 illustrates an exemplary hardware architecture of a server in accordance with an aspect of the disclosure.

FIG. 5 illustrates a hybrid self-organizing network (SON) architecture according to at least one aspect of the disclosure.

FIGS. 6A and 6B illustrate examples of backhaul monitoring in hybrid SONs according to at least one aspect of the disclosure.

FIG. 7 illustrates an exemplary flow in which measurements of uplink/downlink backhaul bandwidth are used to adapt the transmission power range of specific evolved NodeBs (eNBs).

FIGS. 8A-C illustrate exemplary flows for improving local UE handoff based on wide-range uplink/downlink backhaul bandwidth and traffic evaluation according to an aspect of the disclosure.

FIG. 9 illustrates an exemplary flow for centralized SON (cSON) adaptation of the backhaul uplink rate limit according to at least one aspect of the disclosure.

FIG. 10 is a flow diagram illustrating an example method of providing load balancing assistance to a plurality of small cell base stations.

FIG. 11 is a simplified block diagram of several sample aspects of components that may be employed in communication nodes and configured to support communication as taught herein.

FIG. 12 is a simplified block diagram of several sample aspects of an apparatus configured to support communication as taught herein.

FIG. 13 illustrates an example communication system environment in which the teachings and structures herein may be may be incorporated.

### DETAILED DESCRIPTION

Aspects of the disclosure extend existing distributed self-organizing network (dSON) load balancing solutions involving neighborhood small cells (NSC) backhaul monitoring (BHM) by adding centralized SON functionality. A central SON (cSON) server can collect relevant backhaul-related and radio-related information for a larger portion of the network, and assist the local dSON algorithms by providing detailed information about the neighborhood. The local SON functions balance the cell traffic loads according to the individual backhaul capacities. Local dSON information can be combined with global cSON data for improved resolution of backhaul limitations to, for example, adapt evolved NodeB (eNB) transmission power range based on wide-range uplink/downlink backhaul bandwidth evaluation, improve local user equipment (UE) handoff based on wide-range uplink/downlink backhaul bandwidth and traffic evaluation, improve local UE handoff based on Handover Aggressiveness Level adaptation, and/or effectively adapt the cSON of the local uplink Backhaul Rate Limit based on wide-range uplink/downlink backhaul bandwidth and traffic evaluation.

These and other aspects of the disclosure are provided in the following description and related drawings directed to various examples provided for illustration purposes. Alternate aspects may be devised without departing from the scope of the disclosure. Additionally, well-known aspects of the disclosure may not be described in detail or may be omitted so as not to obscure more relevant details.

Those of skill in the art will appreciate that the information and signals described below may be represented using any of a variety of different technologies and techniques. For example, data, instructions, commands, information, signals, bits, symbols, and chips that may be referenced throughout the description below may be represented by voltages, currents, electromagnetic waves, magnetic fields or particles, optical fields or particles, or any combination thereof, depending in part on the particular application, in part on the desired design, in part on the corresponding technology, etc.

Further, many aspects are described in terms of sequences of actions to be performed by, for example, elements of a computing device. It will be recognized that various actions described herein can be performed by specific circuits (e.g., Application Specific Integrated Circuits (ASICs)), by program instructions being executed by one or more processors, or by a combination of both. In addition, for each of the aspects described herein, the corresponding form of any such aspect may be implemented as, for example, “logic configured to” perform the described action.

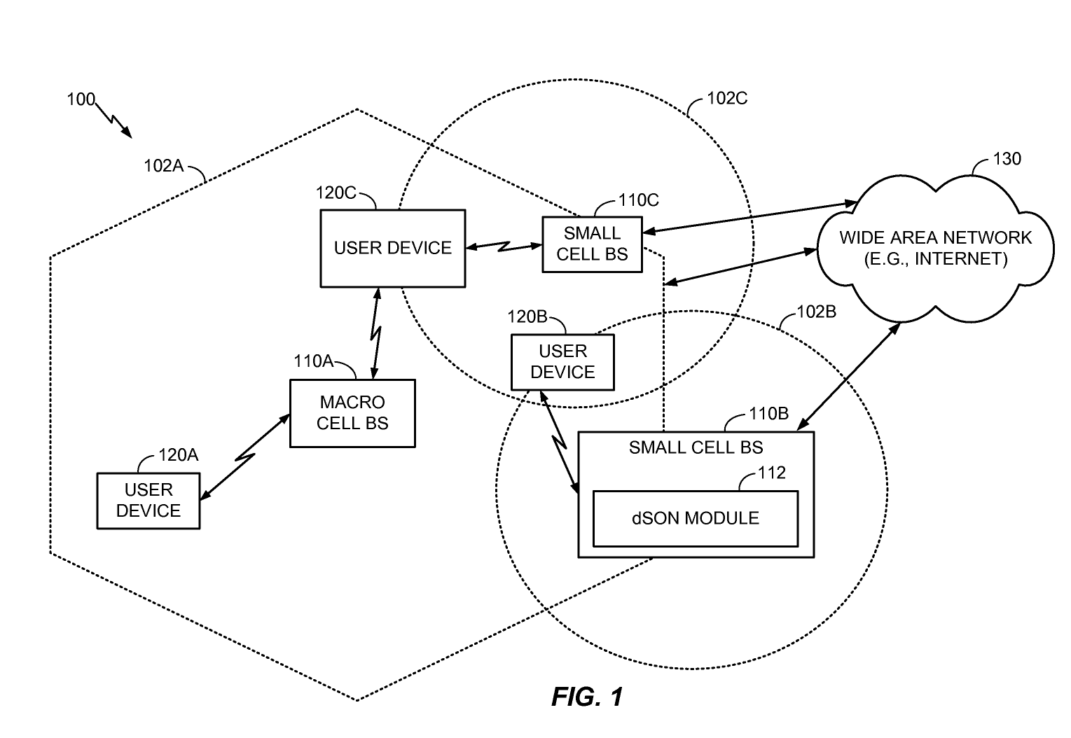

FIG. 1 illustrates an example mixed-deployment wireless communication system, in which small cell base stations are deployed in conjunction with and to supplement the coverage of macro cell base stations. As used herein, small cells generally refer to a class of low-powered base stations that may include or be otherwise referred to as femto cells, pico cells, micro cells, etc. As noted in the background above, they may be deployed to provide improved signaling, incremental capacity growth, richer user experience, and so on.

The illustrated wireless communication system 100 is a multiple-access system that is divided into a plurality of cells 102A-C and configured to support communication for a number of users. Communication coverage in each of the cells 102A-C is provided by a corresponding base station 110A-C, which interacts with one or more user devices 120A-C via downlink (DL) and/or uplink (UL) connections. In general, the DL corresponds to communication from a base station to a user device, while the UL corresponds to communication from a user device to a base station.

As will be described in more detail below, these different entities may be variously configured in accordance with the teachings herein to provide or otherwise support the cSON-aided small cell load balancing based on backhaul information discussed briefly above. For example, one or more of the small cell base stations 110B, 110C may include a dSON module 112, as described herein.

As used herein, the terms “user device” and “base station” are not intended to be specific or otherwise limited to any particular Radio Access Technology (RAT), unless otherwise noted. In general, such user devices may be any wireless communication device (e.g., a mobile phone, router, personal computer, server, etc.) used by a user to communicate over a communications network, and may be alternatively referred to in different RAT environments as an Access Terminal (AT), a Mobile Station (MS), a Subscriber Station (STA), a UE, etc. Similarly, a base station may operate according to one of several RATs in communication with user devices depending on the network in which it is deployed, and may be alternatively referred to as an Access Point (AP), a Network Node, a NodeB, an evolved NodeB (eNB), etc. In addition, in some systems, a base station may provide purely edge node signaling functions while in other systems it may provide additional control and/or network management functions.

Returning to FIG. 1, the different base stations 110A-C include an example macro cell base station 110A and two example small cell base stations 110B, 110C. The macro cell base station 110A is configured to provide communication coverage within a macro cell coverage area 102A, which may cover a few blocks within a neighborhood or several square miles in a rural environment. Meanwhile, the small cell base stations 110B, 110C are configured to provide communication coverage within respective small cell coverage areas 102B, 102C, with varying degrees of overlap existing among the different coverage areas. In some systems, each cell may be further divided into one or more sectors (not shown).

Turning to the illustrated connections in more detail, the user device 120A may transmit and receive messages via a wireless link with the macro cell base station 110A, the message including information related to various types of communication (e.g., voice, data, multimedia services, associated control signaling, etc.). The user device 120B may similarly communicate with the small cell base station 110B via another wireless link, and the user device 120C may similarly communicate with the small cell base station 110C via another wireless link. In addition, in some scenarios, the user device 120C, for example, may also communicate with the macro cell base station 110A via a separate wireless link in addition to the wireless link it maintains with the small cell base station 110C.

As is further illustrated in FIG. 1, the macro cell base station 110A may communicate with a corresponding wide area or external network 130, via a wired link or via a wireless link, while the small cell base stations 110B, 110C may also similarly communicate with the network 130, via their own wired or wireless links. For example, the small cell base stations 110B, 110C may communicate with the network 130 by way of an Internet Protocol (IP) connection, such as via a Digital Subscriber Line (DSL, e.g., including Asymmetric DSL (ADSL), High Data Rate DSL (HDSL), Very High Speed DSL (VDSL), etc.), a TV cable carrying IP traffic, a Broadband over Power Line (BPL) connection, an Optical Fiber (OF) cable, a satellite link, or some other link.

The network 130 may comprise any type of electronically connected group of computers and/or devices, including, for example, Internet, Intranet, Local Area Networks (LANs), or Wide Area Networks (WANs). In addition, the connectivity to the network may be, for example, by remote modem, Ethernet (IEEE 802.3), Token Ring (IEEE 802.5), Fiber Distributed Datalink Interface (FDDI) Asynchronous Transfer Mode (ATM), Wireless Ethernet (IEEE 802.11), Bluetooth (IEEE 802.15.1), or some other connection. As used herein, the network 130 includes network variations such as the public Internet, a private network within the Internet, a secure network within the Internet, a private network, a public network, a value-added network, an intranet, and the like. In certain systems, the network 130 may also comprise a Virtual Private Network (VPN).

Accordingly, it will be appreciated that the macro cell base station 110A and/or either or both of the small cell base stations 110B, 110C may be connected to the network 130 using any of a multitude of devices or methods. These connections may be referred to as the “backbone” or the “backhaul” of the network, and may in some implementations be used to manage and coordinate communications between the macro cell base station 110A, the small cell base station 110B, and/or the small cell base station 110C. In this way, as a user device moves through such a mixed communication network environment that provides both macro cell and small cell coverage, the user device may be served in certain locations by macro cell base stations, at other locations by small cell base stations, and, in some scenarios, by both macro cell and small cell base stations.

For their wireless air interfaces, each base station 110A-C may operate according to one or more of several RATs depending on the network in which it is deployed. These networks may include, for example, Code Division Multiple Access (CDMA) networks, Time Division Multiple Access (TDMA) networks, Frequency Division Multiple Access (FDMA) networks, Orthogonal FDMA (OFDMA) networks, Single-Carrier FDMA (SC-FDMA) networks, and so on. The terms “network” and “system” are often used interchangeably. A CDMA network may implement a RAT such as Universal Terrestrial Radio Access (UTRA), cdma2000, etc. UTRA includes Wideband-CDMA (W-CDMA) and Low Chip Rate (LCR). cdma2000 covers IS-2000, IS-95 and IS-856 standards. A TDMA network may implement a RAT such as Global System for Mobile Communications (GSM). An OFDMA network may implement a RAT such as Evolved UTRA (E-UTRA), IEEE 802.11, IEEE 802.16, IEEE 802.20, Flash-OFDM®, etc. UTRA, E-UTRA, and GSM are part of Universal Mobile Telecommunication System (UMTS). Long Term Evolution (LTE) is a release of UMTS that uses E-UTRA. UTRA, E-UTRA, GSM, UMTS, and LTE are described in documents from an organization named “3rd Generation Partnership Project” (3GPP). cdma2000 is described in documents from an organization named “3rd Generation Partnership Project 2” (3GPP2). These documents are publicly available.

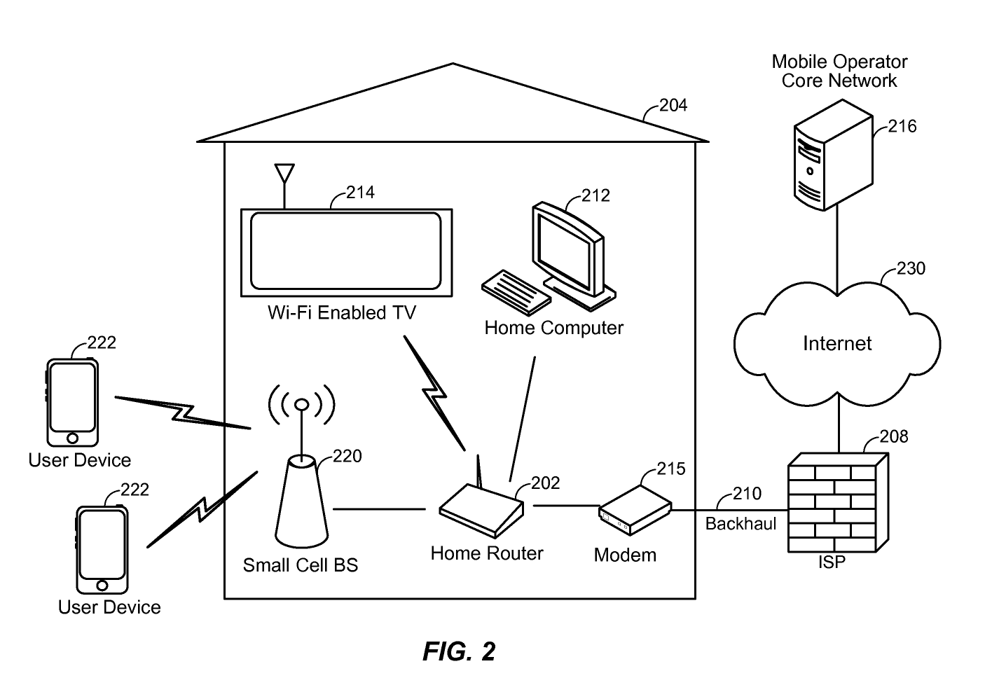

FIG. 2 illustrates an example mixed communication system in which a small cell base station is deployed in the same environment and shares the same backhaul connection as other wired or wireless devices. In this example, a home router 202 is installed in a user residence 204 and provides access to the Internet 230 via an ISP 208. The home router 202 communicates data and other information signaling with the ISP 208 via a modem 215 over a corresponding backhaul link 210. As shown, the home router 202 may support various wired and/or wireless devices, such as a home computer 212, a Wi-Fi enabled TV 214, etc. It will be appreciated that the home router 202 may include or otherwise be integrated with a wireless access point (AP), such as a WLAN AP providing Wi-Fi connectivity to such devices.

A small cell base station 220, such as small cell base station 110B, 110C in FIG. 1, is also installed in the user residence 204 and serves one or more nearby user devices 222, which may correspond to user devices 120A-C in FIG. 1, in accordance with the principles described above. Through its connection to the home router 202 and the shared backhaul link 210, the small cell base station 220 is able to access the Internet 230 and its mobile operator core network/server 216 as shown. Because the backhaul link 210 is shared between the native traffic managed by the small cell base station 220 and the “cross traffic” generated by any other devices that the home router 202 may be serving, there is the potential for congestion of uplink traffic, downlink traffic, or both, with varying degrees of impact on small cell performance as well as the performance of the other devices. The small cell base station 220 is able to determine various backhaul characteristics, such as sustainable throughput on each link, corresponding delay, and jitter variations, etc., to identify backhaul congestion on both the uplink and downlink.

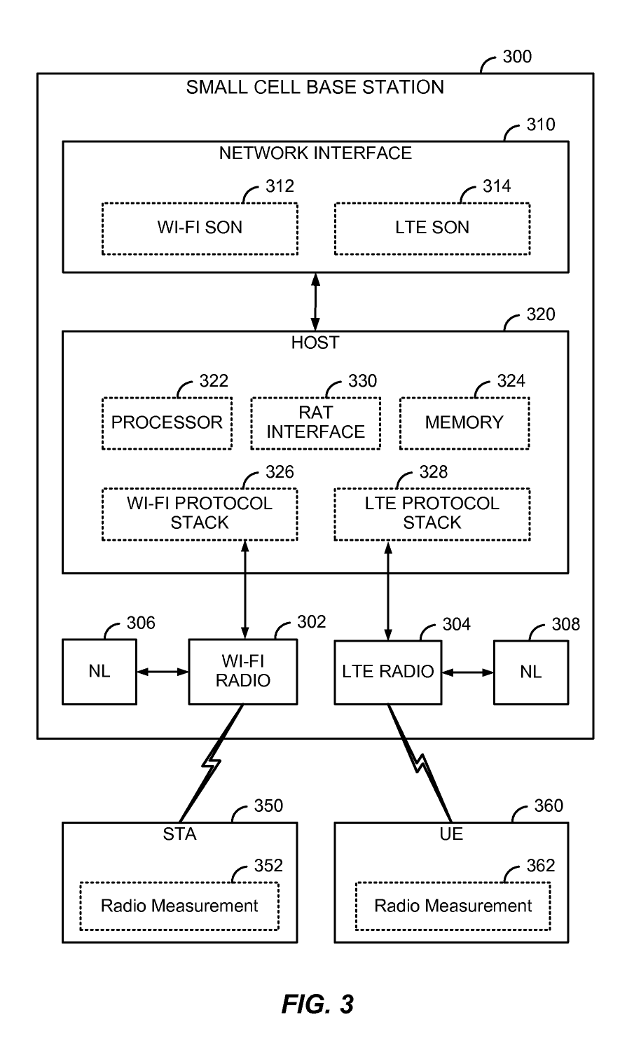

FIG. 3 illustrates an exemplary hardware architecture of a small cell base station with co-located radio components. The small cell base station 300 may correspond to, for example, either of the small cell base stations 110B, 110C illustrated in FIG. 1 and/or the small cell base station 220 illustrated in FIG. 2. In this example, the small cell base station 300 is configured to provide a Wireless Local Area Network (WLAN) air interface (e.g., in accordance with an IEEE 802.11x protocol) in addition to a cellular air interface (e.g., in accordance with an LTE protocol). For illustration purposes, the small cell base station 300 is shown as including an 802.11x radio component/module (e.g., transceiver) 302 co-located with an LTE radio component/module (e.g., transceiver) 304.

As used herein, the term co-located (e.g., radios, base stations, transceivers, etc.) may include in accordance with various aspects, one or more of, for example: components that are in the same housing; components that are hosted by the same processor; components that are within a defined distance of one another; and/or components that are connected via an interface (e.g., an Ethernet switch) where the interface meets the latency requirements of any required inter-component communication (e.g., messaging).

Returning to FIG. 3, the Wi-Fi radio 302 and the LTE radio 304 may perform monitoring of one or more channels (e.g., on a corresponding carrier frequency) to perform various corresponding operating channel or environment measurements (e.g., CQI, RSSI, RSRP, or other RLM measurements) using corresponding Network/Neighbor Listen (NL) modules 306 and 308, respectively, or any other suitable component(s).

The small cell base station 300 may communicate with one or more user devices via the Wi-Fi radio 302 and the LTE radio 304, illustrated as a STA 350 and a UE 360, respectively. STA 350 and UE 360 may correspond to user devices 120A-C in FIG. 1 and/or user devices 222 in FIG. 2. Similar to the Wi-Fi radio 302 and the LTE radio 304, the STA 350 includes a corresponding radio measurement module 352 and the UE 360 includes a corresponding radio measurement module 362 for performing various operating channel or environment measurements, either independently or under the direction of the Wi-Fi radio 302 and the LTE radio 304, respectively. In this regard, the measurements may be retained at the STA 350 and/or the UE 360, or reported to the Wi-Fi radio 302 and the LTE radio 304, respectively, with or without any pre-processing being performed by the STA 350 or the UE 360.

While FIG. 3 shows a single STA 350 and a single UE 360 for illustration purposes, it will be appreciated that the small cell base station 300 can communicate with multiple STAs and/or UEs. Additionally, while FIG. 3 illustrates one type of user device communicating with the small cell base station 300 via the Wi-Fi radio 302 (i.e., the STA 350) and another type of user device communicating with the small cell base station 300 via the LTE radio 304 (i.e., the UE 360), it will be appreciated that a single user device (e.g., a smartphone) may be capable of communicating with the small cell base station 300 via both the Wi-Fi radio 302 and the LTE radio 304, either simultaneously or at different times.

As is further illustrated in FIG. 3, the small cell base station 300 may also include a network interface 310, which may include various components for interfacing with corresponding network entities (e.g., Self-Organizing Network (SON) nodes), such as a component for interfacing with a Wi-Fi SON 312 and/or a component for interfacing with an LTE SON 314. Either or both of the Wi-Fi SON 312 and the LTE SON 314 may correspond to the dSON module 112 in FIG. 1. The small cell base station 300 may also include a host 320, which may include one or more general purpose controllers or processors 322 and memory 324 configured to store related data and/or instructions. The host 320 may perform processing in accordance with the appropriate RAT(s) used for communication (e.g., via a Wi-Fi protocol stack 326 and/or an LTE protocol stack 328), as well as other functions for the small cell base station 300. In particular, the host 320 may further include a RAT interface 330 (e.g., a bus or the like) that enable both the Wi-Fi radio 302 and the LTE radio 304 to communicate with one another via various message exchanges.

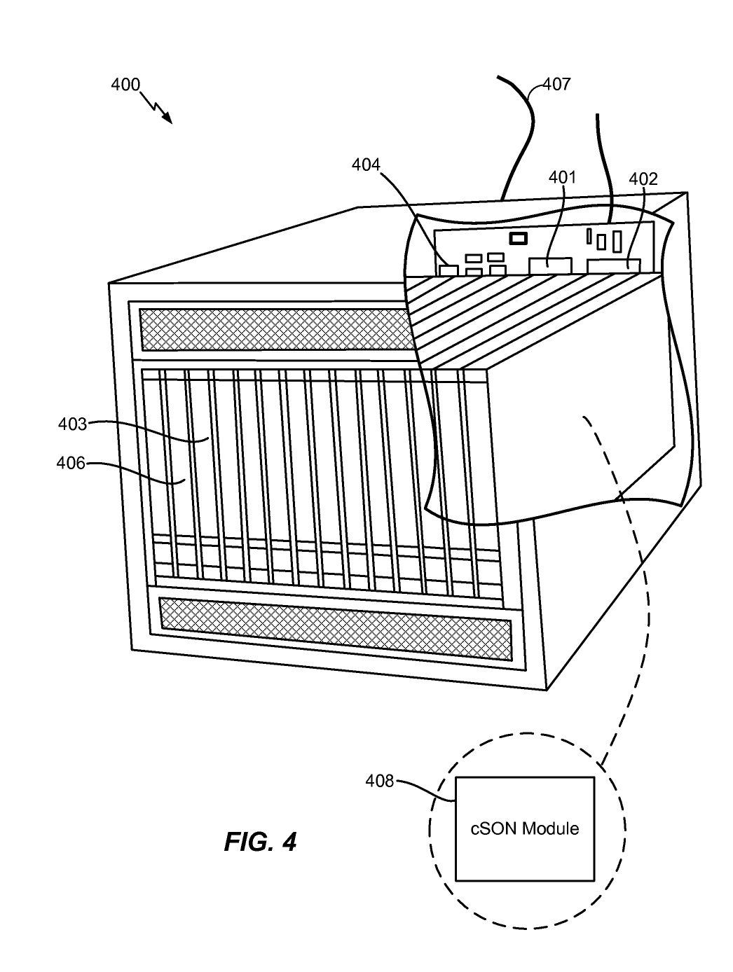

The various embodiments may be implemented on any of a variety of commercially available server devices, such as server 400 illustrated in FIG. 4. In an example, the server 400 may correspond to a server in a network operator's core network, such as mobile operator core network/server 216 in FIG. 2, which is configured to implement cSON-aided small cell load balancing based on backhaul information, as described herein. The exemplary server 400 illustrated in FIG. 4 includes a processor 401 coupled to volatile memory 402 and a large capacity nonvolatile memory, such as a disk drive 403. The server 400 may also include a floppy disc drive, compact disc (CD), or DVD disc drive 406 coupled to the processor 401. The server 400 may also include network access ports 404 coupled to the processor 401 for establishing data connections with a network 407, such as a local area network coupled to other broadcast system computers and servers or to the Internet 230 in FIG. 2. In addition, the server 400 may include a cSON module 408, as described herein. The cSON module 408 may be a module stored in the memory of the server 400, such as volatile memory 402, disk drive 403, or disc drive 406, and executable by the processor 401. Alternatively, the cSON module 408 may be a hardware or firmware component coupled to or integrated into the processor 401.

Accordingly, an embodiment of the disclosure can include a server (e.g., server 400) including the ability to perform the functions described herein. As will be appreciated by those skilled in the art, the various logic elements can be embodied in discrete elements, software modules executed on a processor or any combination of software and hardware to achieve the functionality disclosed herein. For example, processor 401, cSON module 408, volatile and/or nonvolatile memory 402 and 403, and/or network access ports 404 may all be used cooperatively to load, store and execute the various functions disclosed herein, and thus logic/circuitry/executable modules to perform these functions may be distributed over various elements. Alternatively, the functionality could be incorporated into one discrete component. Therefore, the features of server 400 are to be considered merely illustrative and the disclosure is not limited to the illustrated features or arrangement.

For example, the network access ports 404 may be configured to receive periodic or event-triggered backhaul capacity reports from each of a plurality of small cell base stations, such as small cell base station 220 in FIG. 2 and/or small cell base station 300 in FIG. 3, as described herein. The cSON module 408, optionally in conjunction with the processor 401, may be configured to determine load balancing assistance data for at least one of the plurality of small cell base stations based on the backhaul capacity reports, as described herein. The cSON module 408 may be further configured to cause the network access ports 404 to provide the load balancing assistance data to the at least one of the plurality of small cell base stations, as described herein.

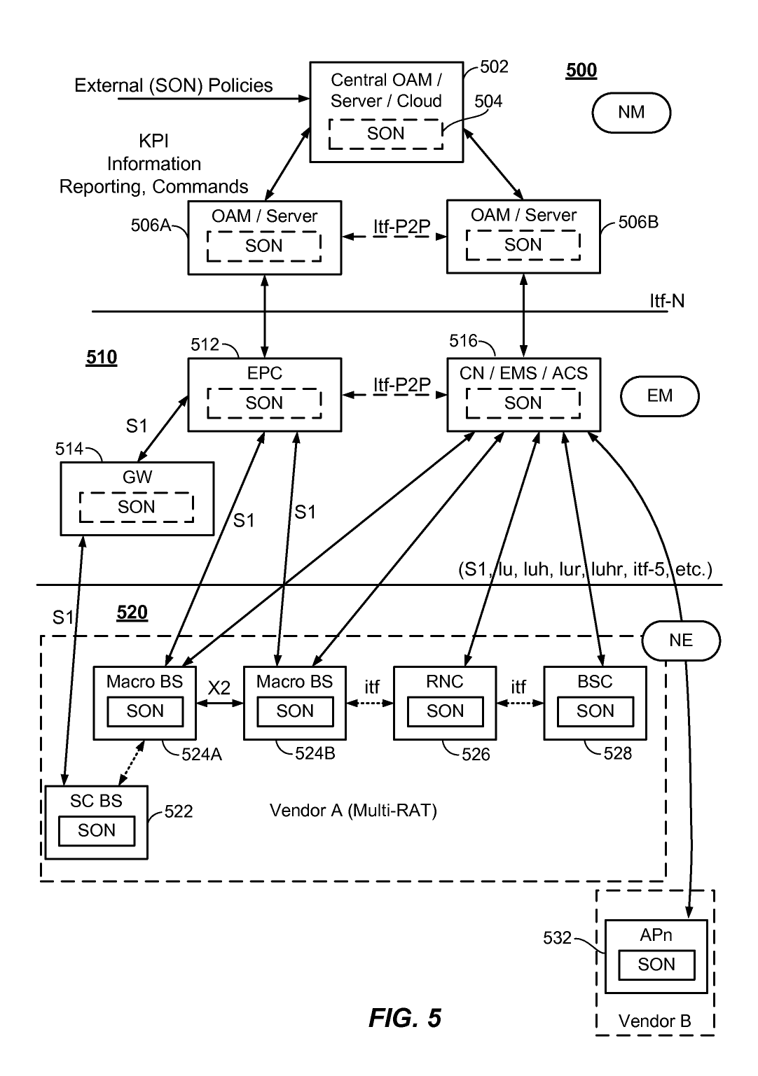

SON load balancing based on backhaul monitoring (BHM) can be improved by adding a cSON server or module to the existing architecture. FIG. 5 illustrates a hybrid SON architecture according to at least one aspect of the disclosure. Note that FIG. 5 illustrates components that could be included in the hybrid architecture, but need not be included. A typical hybrid architecture will generally have fewer components than illustrated in FIG. 5.

As illustrated in FIG. 5, a network management (NM) layer 500 includes a central Operation and Maintenance (OAM) or server (such as mobile operator core network/server 216 in FIG. 2 and/or server 400 in FIG. 4) or the Cloud 502 (referred to herein as “server 502” for simplicity) that receives external SON policies. The server 502 includes a SON module 504 configured to provide the cSON functionality described herein, such as cSON module 408 in FIG. 4. The SON module 504 may be in communication with OAMs/servers 506A and 506B and may, for example, exchange KPI Information Reporting Commands with the OAMs/servers 506A and 506B. The OAMs/servers 506A and 506B may also be in communication with each other over, for example, a P2P (peer-to-peer) interface (itf).

An element management (EM) layer 510 includes an evolved packet core (EPC) 512, a gateway (GW) 514, and a core network (CN)/element management system (EMS)/auto-configuration server (ACS) 516, each with respective SON modules. The EPC 512 may communicate with the GW 514 over an S1 interface, and with the CN/EMS/ACS 516 over a P2P interface. The interface between the EM layer 510 and the OAM/servers 506A and 506B may be an N interface (“itf-N”).

A network element (NE) layer 520 includes various base stations (BSs) belonging to a first vendor or network operator (Vendor A) and a second vendor or network operator (Vendor B). Specifically, the base stations belonging to Vendor A may include a small cell base station (SC BS) 522 (such as small cell base station 110B, 110C in FIG. 1, small cell base station 220 in FIG. 2, and/or small cell base station 300 in FIG. 3), macro base stations 524A and 524B (such as macro cell base station 110A in FIG. 1), a radio network controller (RNC) 526, and/or a base station controller (BSC) 528. The base stations belonging to Vendor B include any number (n) of other base stations 532. As illustrated in FIG. 5, each base station may include a SON module. The SON modules included in base stations 522, 524A, and 524B are dSON modules.

As shown in FIG. 5, the EPC 512 and the GW 514 may communicate with base stations 522, 524A, and 524B over an S1 interface. The interface between the EPC 512, GW 514, and CN/EMS/ACS 516 and the base stations 522-532 may be an S1, lu, luh, lub, lur, luhr, 5, etc., interface.

Although FIG. 5 illustrates an SON module on each component of the NM layer 500 and EM layer 510 of the hybrid architecture, this is not required (hence the dashed lines of each SON module), and there may instead be only one SON module across the NM and EM layers 500 and 510 (which would be a cSON module, such as cSON module 408 in FIG. 4). However, in the NE layer 520, there may be dSON modules (such as dSON module 112 in FIG. 1) at each of base stations 522-532. Note that the cSON module in the NM and EM layers 500 and 510 can reside at any component in the NM 500 and EM 510 layers; it need not reside at server 502.

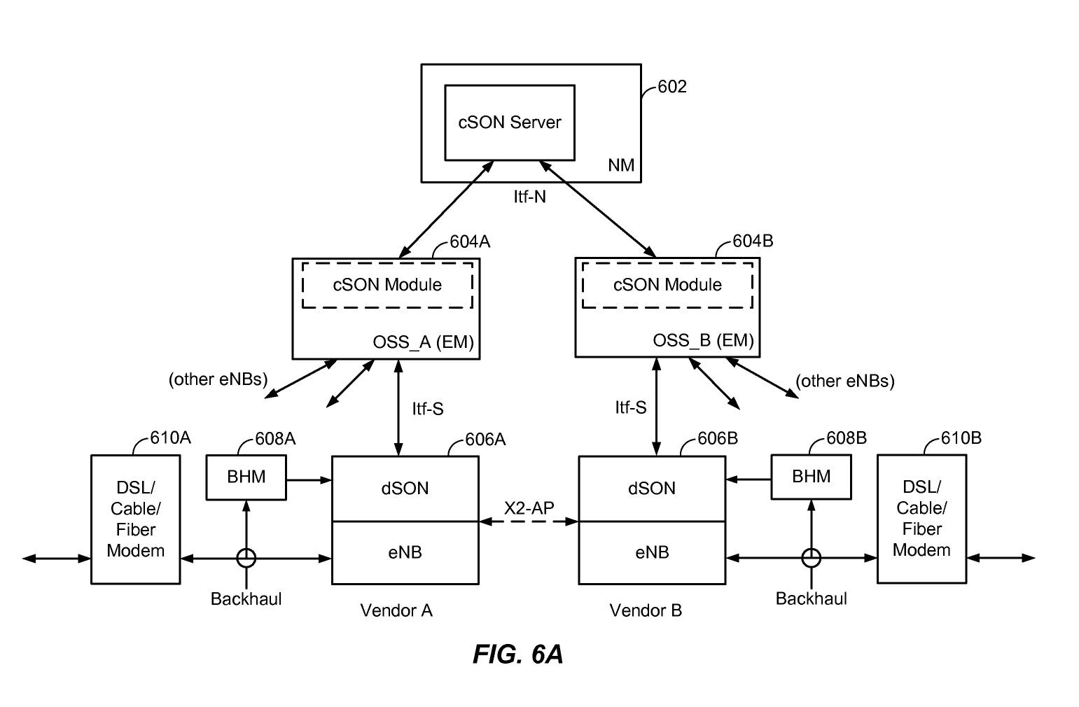

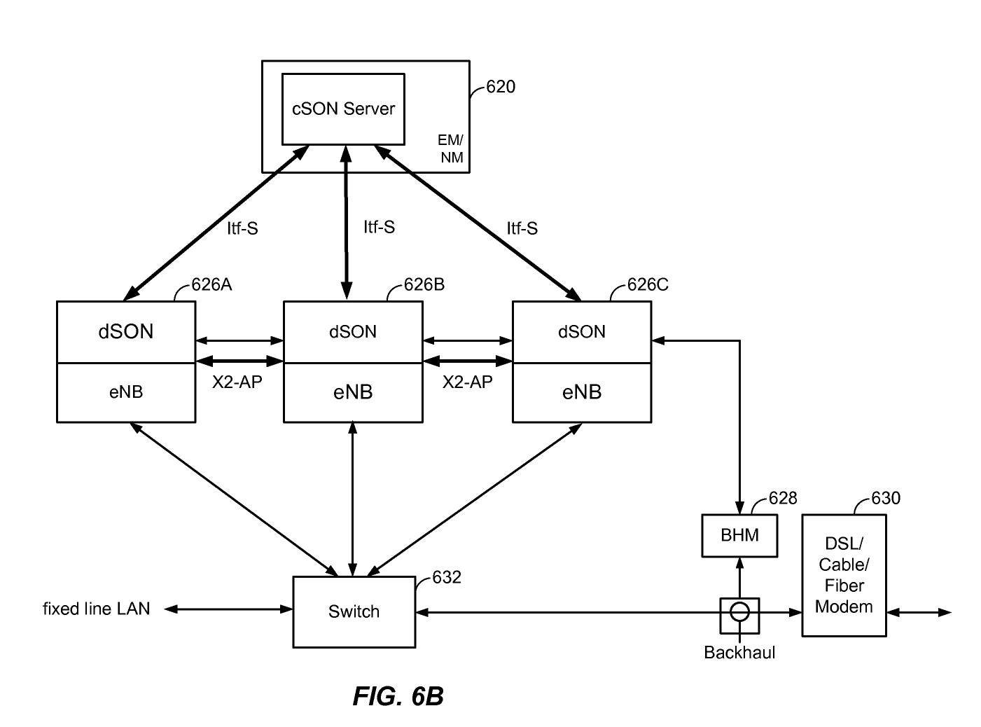

FIG. 6A illustrates an example of backhaul monitoring in a hybrid SON according to at least one aspect of the disclosure. A cSON server 602, such as mobile operator core network/server 216 in FIG. 2, server 400 in FIG. 4, and/or server 502 in FIG. 5, may be any core network server that includes a cSON module, such as cSON module 408 in FIG. 4. Alternatively, the cSON server 602 may be dedicated to the cSON functionality described herein.

The cSON server 602 resides in the NM layer and communicates with an Operation and Support System A (OSS_A) 604A and an OSS_B 604B in the EM layer over an N interface (“itf-N”). The OSS_A 604A and the OSS_B 604B may also include cSON modules. The OSS_A 604A communicates over an S interface (“itf-S”) with one or more eNBs 606A belonging to a Vendor A, and the OSS_B 604B communicates with one or more eNBs 606B belonging to a Vendor B. eNBs 606A and 606B may correspond to, for example, small cell base stations 110B, 110C in FIG. 1, small cell base station 220 in FIG. 2, and/or small cell base station 300 in FIG. 3. The eNBs 606A-B each include a dSON module, as discussed herein, and may communicate with each other over an X2-AP interface.

BHM functions 608A and 608B may provide measurements of the backhaul between modems 610A and 610B and eNBs 606A and 606B, respectively. These measurements support various hybrid SON algorithms, as described herein. Modems 610A and 610B may correspond to, for example, modem 215 in FIG. 2.

Note that although illustrated in FIGS. 5 and 6 as embodied in server 502 and cSON server 602, respectively, the cSON module can reside on any management entity in the NM or EM layers (hence the dashed lines of each cSON module). There may be one cSON module, or the cSON module may be distributed across several entities. For example, as illustrated in FIG. 5, any SON module that is not incorporated into one of base stations 522-532 would be considered a cSON module, such as cSON module 408 in FIG. 4. Similarly, FIG. 6A illustrates that the cSON module can reside in the cSON server 602, the OSS_A 604A, and/or the OSS_B 604B. Alternatively, the cSON module may reside on an eNB, provided it can perform the functionality described herein.

Further, although FIG. 6A illustrates that eNBs 606A and 606B from Vendors A and B, respectively, communicate directly over the X2-AP interface, this is not necessary to the various aspects of the disclosure.

FIG. 6B illustrates an example of backhaul monitoring in a hybrid SON having a shared backhaul according to at least one aspect of the disclosure. The architecture illustrated in FIG. 6B may correspond to an enterprise deployment of a plurality of small cell base stations, where the small cell base stations are each connected to the same backhaul.

Referring to FIG. 6B, a cSON server 620, such as mobile operator core network/server 216 in FIG. 2, server 400 in FIG. 4, server 502 in FIG. 5, or cSON server 602 in FIG. 6A, may be any core network server that includes a cSON module, such as cSON module 408 in FIG. 4. Alternatively, the cSON server 620 may be dedicated to the cSON functionality described herein. In this embodiment, the cSON server 620 encompasses the functionality of the EM and NM layers discussed above with reference to FIGS. 5 and 6A. The cSON server 620 communicates over an S interface (“itf-S”) with eNBs 626A-C, which may correspond to, for example, small cell base stations 110B, 110C in FIG. 1, small cell base station 220 in FIG. 2, and/or small cell base station 300 in FIG. 3. The eNBs 626A-C each include a dSON module, as discussed herein, and may communicate with each other over an X2-AP interface.

In FIG. 6B, BHM functions 628 provide measurements of the backhaul between the modem 630 and the switch 632. These measurements support various hybrid SON algorithms, as described herein. The modem 630 may correspond to, for example, the modem 215 in FIG. 2. The switch 632 may correspond to, for example, the home router 202 in FIG. 2.

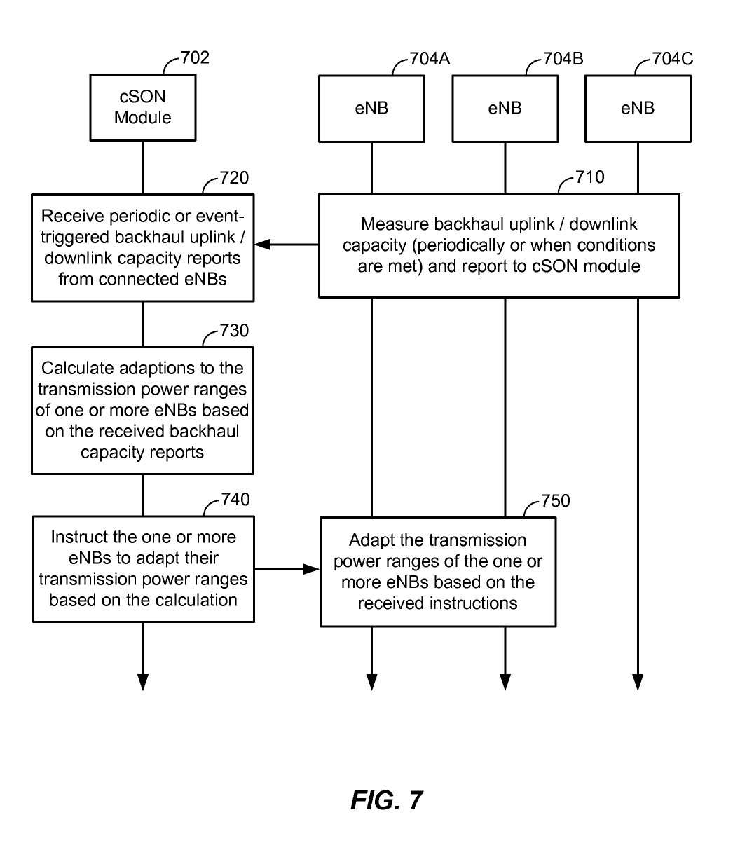

Referring to the specific improvements enabled by the cSON module, FIG. 7 illustrates an exemplary flow in which BHM measurements of uplink/downlink backhaul bandwidth are used to adapt the transmission power range of specific eNBs, thereby adapting the coverage area of the eNBs.

In other systems, eNB transmission power range adaptation is based on a local dSON module decision, typically performed at the specific eNB. For example, if several eNBs in an NSC deployment become overloaded, they may each independently reduce their coverage area (also referred to herein as “cell area” or “service area”), which may result in holes in network coverage. In the centralized approach, the cSON module can use knowledge of the eNBs' backhaul capacities (from backhaul monitoring reports provided by the BHM function) to enable better adaptation.

Specifically, at 710, the eNBs 704A-C in the network periodically, or based on various conditions (such as poor throughput observations), monitor (e.g., measure) their backhaul uplink/downlink capacity and report it to the cSON module 702, such as cSON module 408 of FIG. 4. The cSON module 702 may be incorporated into a network operator server, such as mobile operator core network/server 216 in FIG. 2, server 400 in FIG. 4, server 503 in FIG. 5, server 602 in FIG. 6A, or cSON server 620 in FIG. 6B. Alternatively, the cSON module may reside on another component of the NM or EM layers, or may be distributed across several components of the NM and EM layers. The eNBs 704A-C may be small cell base stations, such as small cell base stations 110B, 110C in FIG. 1, small cell base station 220 in FIG. 2, small cell base station 300 in FIG. 3, small cell base station 522 in FIG. 5, eNBs 606A, 606B in FIG. 6A, or eNBs 626A-C in FIG. 6B.

At 720, the cSON module 702 receives the periodic or event-triggered backhaul uplink/downlink capacity reports from the eNBs 704A-C. Examples of triggering events may be low throughput or poor backhaul statistics observations. Although FIG. 7 only illustrates three eNBs, it will be appreciated that the cSON module 702 can collect this backhaul data from each eNB in the network operator's entire network (or service area), for example, the Verizon® or AT&T® networks. Such a network can include macro cell base stations, as well as small cell base stations, from different hardware vendors, which have been approved by the network operator for operation in the network.

At 730, the cSON module 702 can calculate adaptions for one or more of the eNBs' 704A-C transmission power ranges (and thereby those eNBs' service areas) based on the received backhaul capacity reports to balance UE traffic and available backhaul via cell footprint control. In the example of FIG. 7, the cSON module 702 calculates adaptions for eNBs 704A-B. At 740, the cSON module 702 sends instructions to eNBs 704A-B to adapt their transmission power ranges. At 750, eNBs 704A-B receive the instructions and adapt their transmission power ranges accordingly.

The adaptations need not be the same for each eNB. For example, the cSON module 702 may instruct eNB 704A to reduce its coverage area, while instructing neighboring eNB 704B to enlarge its coverage area. UEs in coverage border regions will automatically handover, thereby distributing the traffic load according to backhaul capacity. Such centralized control is superior to localized control because the cSON module 702 can adapt coverage ranges of neighboring eNBs simultaneously. This avoids both coverage holes and overlapping coverage areas. Note that transmission power range can be adapted together with the transmit power management (TPM) SON function.

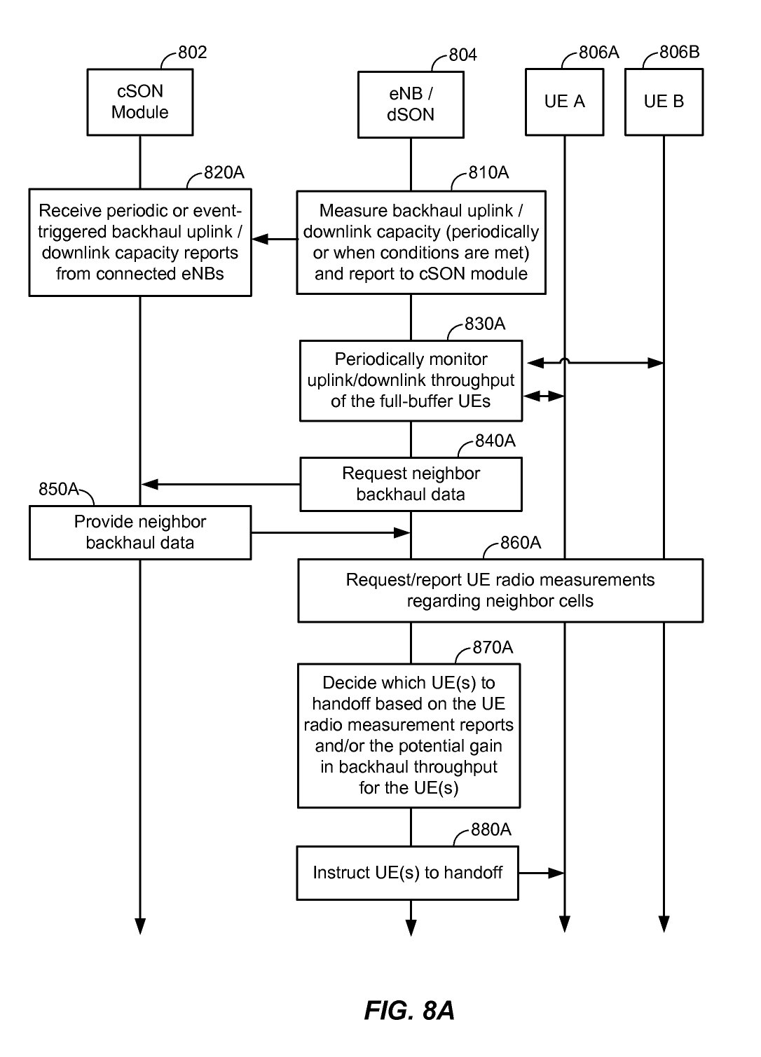

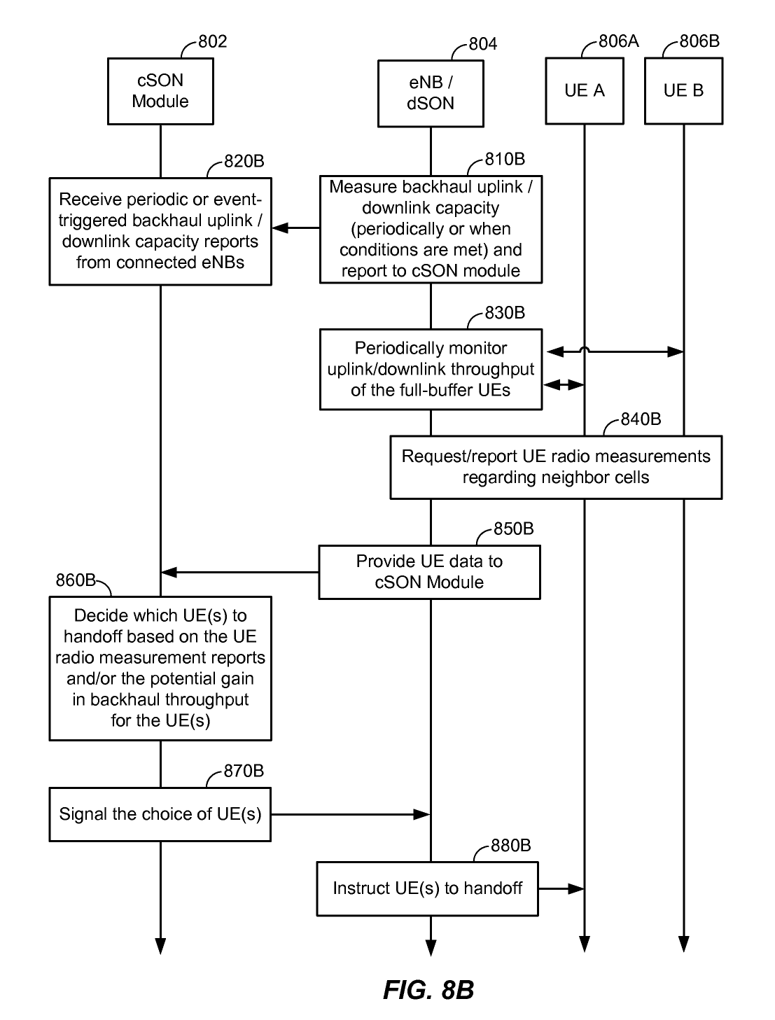

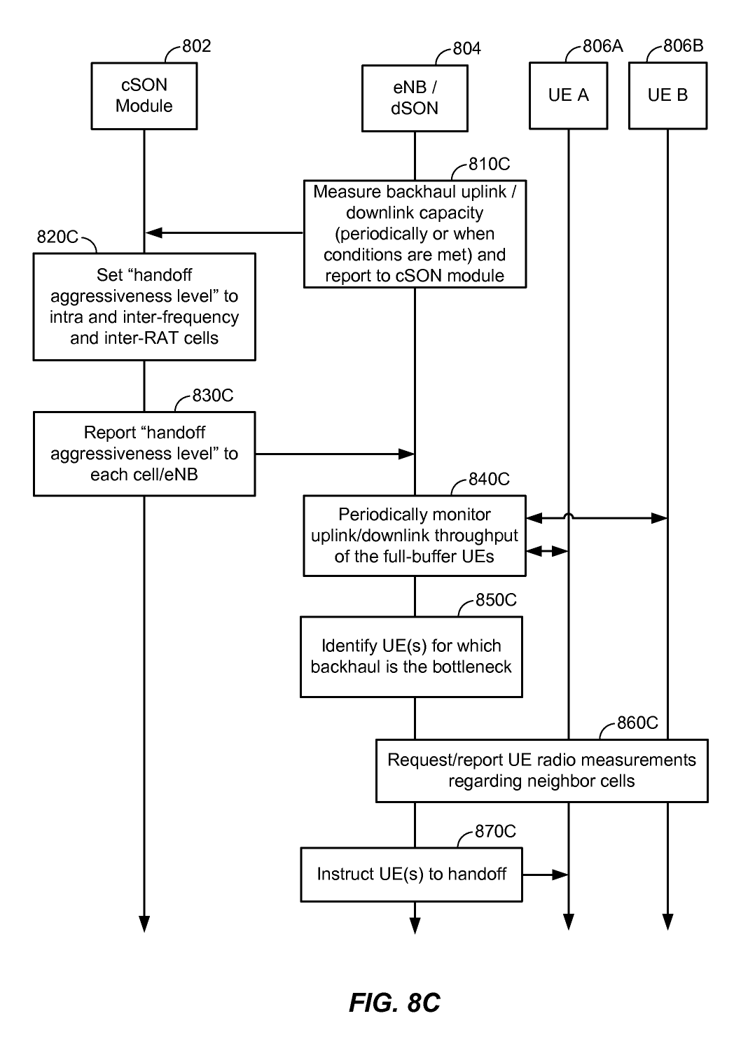

FIG. 8A illustrates an exemplary flow for improving local UE handoff based on wide-range uplink/downlink backhaul bandwidth and traffic evaluation according to an aspect of the disclosure.

In other systems, UE handoff is based on a local dSON module decision. In the centralized approach, the cSON module can use its extended knowledge of neighboring eNBs' backhaul bandwidths and loads to improve dSON module handoff decisions, or to make/initiate the handoff decision for the eNB.

Specifically, at 810A, an eNB 804, such as any of eNBs 704A-C in FIG. 7, monitors (e.g., measures) its backhaul uplink/downlink capacity, including the current traffic on the uplink/downlink, periodically or when certain measurement conditions (such as low throughput) are met, and reports it to the cSON module 802, such as cSON module 702 in FIG. 7. At 820A, the cSON module 802 receives these periodic or event-triggered backhaul uplink/downlink capacity reports from the eNB 804. Although FIG. 8A only illustrates one eNB, as in FIG. 7, persons skilled in the art will appreciate that the cSON module 802 may collect this backhaul data for the whole network.

At 830A, the eNB 804 periodically monitors uplink/downlink throughput of the full-buffer UEs 806A-B (referred to as Light Passive Estimation). The full-buffer UEs 806A-B may correspond to the UEs that have (or appear to have from the eNB perspective) more data in their buffers than they are able to transmit at the current bandwidth. Periodic monitoring may be modulated by instances such as flow start/end/addition. Alternatively, the eNB 804 may monitor and report other statistics (e.g., delay, jitter) that impact specific flow (e.g., voice, video) performance. The full-buffer condition can be due to a bottleneck in radio resources or in backhaul capacity. In case of low throughput due to limited backhaul capacity, the eNB 804 checks for which UEs' 806A-B backhaul(s) is/are the bottleneck (referred to as Light Active Estimation).

At 840A, if any such UE(s) is/are identified (here UEs 806A-B), the eNB 804 asks the cSON module 802 for neighboring eNB backhaul data or “neighbor backhaul data”. At 850A, the cSON module 802 provides the neighbor backhaul data (capacity and traffic) to the requesting eNB 804. At 860A, the eNB 804 requests, and the UEs 806A, 806B report, UE radio measurements regarding neighbor cells/eNBs (e.g., radio conditions, signal-to-interference-plus-noise-ratio (SINR) difference, etc.).

At 870A, the dSON module at the eNB 804 decides which of UEs 806A-B to handoff and to which neighboring eNB/cell, depending on the UE radio measurement reports and/or the potential gain in backhaul throughput for the UE(s) (e.g., backhaul conditions, rate difference, etc.). The UE handoff decision can be made together with the mobility load balancing (MLB) SON function. In the example of FIG. 8, at 880A, the eNB 804 instructs UE 806A to handoff.

Although FIG. 8A illustrates only one eNB and only two UEs, it will be appreciated that there may be any number of eNBs performing the flow illustrated in FIG. 8A, and that there may be any number of UEs served by those eNBs, including eNB 804. Additionally, eNB 804 may instruct any or none of the UEs it is serving to handoff based on the received neighbor backhaul data and/or UE measurement reports.

FIG. 8B illustrates an alternative flow for improving local UE handoff based on wide-range uplink/downlink backhaul bandwidth and traffic evaluation according to an aspect of the disclosure.

At 810B, as at 810A, an eNB 804 monitors (e.g., measures) its backhaul uplink/downlink capacity, including the current traffic on the uplink/downlink, periodically or in response to some event and reports it to the cSON module 802. Periodic monitoring may be modulated by instances such as flow start/end/addition; alternatively, the eNB 804 may monitor and report other statistics (e.g., delay, jitter) that impact specific flow (e.g., voice, video) performance. At 820B, the cSON module 802 receives these periodic or event-triggered backhaul uplink/downlink capacity reports from the eNB 804. Although FIG. 8B only illustrates one eNB 804, as in FIG. 7, the cSON module 802 may collect this backhaul data for the whole network.

At 830B, as at 830A, the eNB 804 periodically monitors uplink/downlink throughput of the full-buffer UEs 806A-B (referred to as Light Passive Estimation). As above, periodic monitoring may be modulated by instances such as flow start/end/addition, or the eNB 804 may monitor and report other statistics (e.g., delay, jitter) that impact specific flow (e.g., voice, video) performance. In case of low throughput due to limited backhaul capacity, the eNB 804 checks for and identifies which UEs' 806A-B backhaul(s) is/are the bottleneck (referred to as Light Active Estimation).

At 840B, as at 860A, the eNB 804 requests, and the UEs 806A, 806B report, UE radio measurements regarding neighbor cells/eNBs (e.g., radio conditions, SINR difference, etc.). At 850B, if any UE(s) is/are identified at 830B, the local dSON module provides UE data for those UEs (here UEs 806A-B) to the cSON module 802. The UE data may include the UEs' 806A-B throughput data and the UE radio measurement reports. At 860B, the cSON module 802 analyzes the neighbor backhaul data and the UE data and decides which UE(s) to handoff, if any, and to which neighboring eNB/cell. At 870B, the cSON module 802 signals the choice of UE(s) to the dSON module, and at 880B, the eNB 804 hands off the indicated UE(s), here, UE 806A.

Although FIG. 8B illustrates only one eNB and only two UEs, it will be appreciated that there may be any number of eNBs performing the flow illustrated in FIG. 8B, and that there may be any number of UEs served by those eNBs, including eNB 804. Additionally, cSON 802/eNB 804 may instruct any or none of the UEs being served to handoff based on the received neighbor backhaul data and/or UE measurement reports.

FIG. 8C illustrates another alternative flow for improving local UE handoff based on wide-range uplink/downlink backhaul bandwidth and traffic evaluation according to an aspect of the disclosure.

At 810C, as at 810A-B, an eNB 804 monitors its backhaul uplink/downlink capacity periodically or based on certain conditions and reports it to the cSON module 802. As described above, periodic monitoring may be modulated by instances such as flow start/end/addition, or the eNB 804 may monitor and report other statistics (e.g., delay, jitter) that impact specific flow (e.g., voice, video) performance. Although FIG. 8B only illustrates one eNB 804, as in FIG. 7, the cSON module 802 may collect this backhaul data for the whole network.

At 820C, the cSON module 802 sets an eNB-specific “handoff aggressiveness level” to intra and inter-frequency and inter-RAT cells/eNBs, depending on the backhaul situation in the neighborhood. For example, the cSON module 802 assigns a higher handoff aggressiveness level if the backhaul capacity is larger in neighboring cells. The handoff aggressiveness level also takes into account handoff performance (e.g., radio link failures (RLFs), ping-ponging, etc.). At 830C, the cSON module 802 reports the assigned handoff aggressiveness level to the corresponding cell/eNB.

At 840C, as at 830A-B, the eNB 804 periodically monitors uplink/downlink throughput of full-buffer UEs (Light Passive Estimation). As discussed above, periodic monitoring may be modulated by instances such as flow start/end/addition, or the eNB 804 may monitor and report other statistics (e.g., delay, jitter) that impact specific flow (e.g., voice, video) performance. In case of low throughput due to limited backhaul capacity, at 850C, the eNB 804 determines UE(s) for which backhaul is the bottleneck (referred to as Light Active Estimation). At 860C, as at 860A, 840B, the eNB 804 requests, and the UEs 806A, 806B report, UE radio measurements regarding neighbor cells/eNBs (e.g., radio conditions, SNR difference, etc.).

At 870C, if any UE(s) is/are identified at 850C (here, UEs 806A-B), the local dSON module hands off the most appropriate UE based on UE radio measurement reports and the handoff aggressiveness level received from the cSON module 802 at 830C. A higher handoff aggressiveness level means that the eNB should attempt to handoff one or more UEs that it is serving, whereas a lower handoff aggressiveness level means that the eNB need not handoff the UE(s). Note that the UE handoff decision can be made together with the MLB SON function.

Although FIG. 8C illustrates only one eNB and only two UEs, it will be appreciated that there may be any number of eNBs performing the flow illustrated in FIG. 8C, and that there may be any number of UEs served by those eNBs, including eNB 804. Additionally, cSON 802/eNB 804 may instruct any or none of the UEs being served to handoff based on the received neighbor backhaul data and/or UE measurement reports.

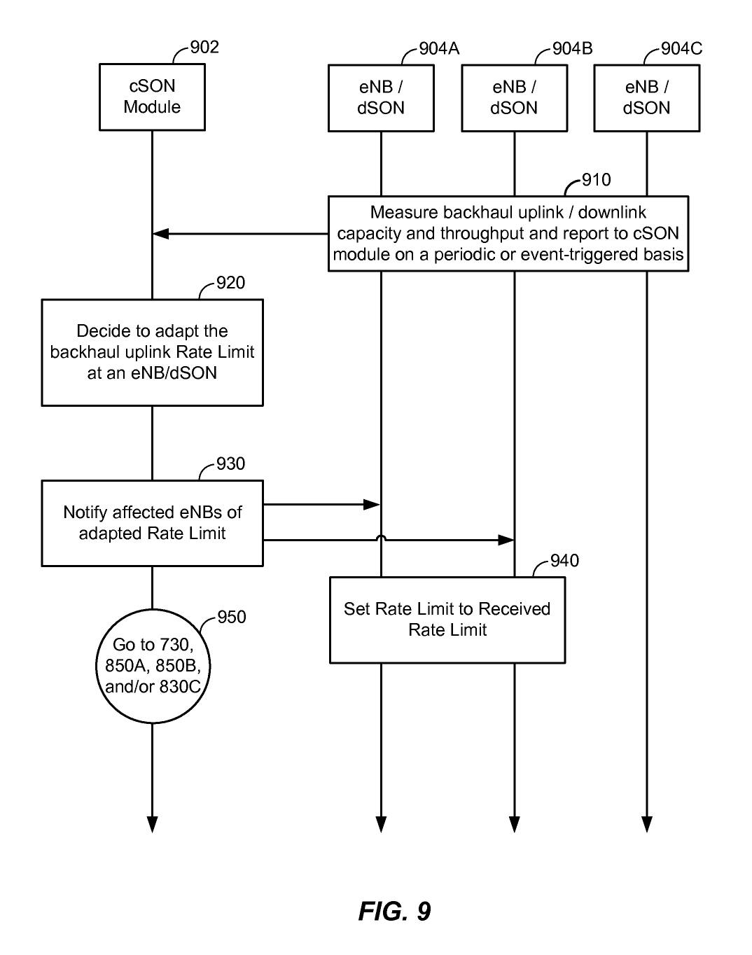

FIG. 9 illustrates an exemplary flow for cSON adaptation of the backhaul uplink Rate Limit according to at least one aspect of the disclosure. In other systems, there is a constant backhaul uplink Rate Limit (which is a fraction of the total backhaul capacity) that is enforced locally. Under the centralized approach, however, cSON module 902, such as cSON module 702 in FIG. 7, can adapt the backhaul uplink Rate Limit and directly enforce it by transmission power range adaptation and/or handoff assistance/initiation, as discussed above with reference to FIGS. 7-8C. For example, in an enterprise deployment where the backhaul is shared among multiple small cell base stations, such as illustrated in FIG. 6B, the cSON module 902 can adapt and enforce the backhaul uplink Rate Limit for individual small cell base stations.

Specifically, a high amount of uplink NSC traffic on the backhaul link can impact the uplink and downlink throughput of a fixed-line LAN sharing the same DSL/cable/fiber backhaul link. This can be caused by, for example, small LAN uplink ACK packets being blocked, slowing down downlink throughput. To solve this problem, the cSON module 902 can impose an uplink Rate Limit (e.g., 90%) on an eNB 904A-C in order to reserve the remaining uplink backhaul capacity (e.g. 10%) to uplink fixed line LAN traffic. Such an improvement may be especially beneficial in an enterprise small cell deployment, where multiple NSC base stations (plus fixed-line LAN) share the same DSL/cable/fiber backhaul link, such as illustrated in FIG. 6B. In this case, the NSC-specific uplink LTE rate limits need to be centrally and dynamically adapted (e.g., depending on NSC status) to achieve meaningful composite NSC uplink rate limits at the shared backhaul.

Referring to FIG. 9, at 910, as at 810 of FIG. 8A, the eNBs 904A-C in an NSC deployment monitor (e.g., measure) backhaul uplink/downlink capacity and throughput (both NSC and non-NSC traffic) at periodic or event-triggered occasions and report this information to the cSON module 902. The eNBs 904A-C may also report relevant RAN measurements (e.g., traffic load, handoff statistics, transmission power, etc.). The eNBs 904A-C may be small cell base stations, such as small cell base stations 110B, 110C in FIG. 1, small cell base station 220 in FIG. 2, small cell base station 300 in FIG. 3, small cell base station 522 in FIG. 5, eNBs 606A, 606B in FIG. 6A, eNBs 626A-C in FIG. 6B, eNBs 704A-C in FIG. 7, and/or eNBs 804A-C in FIG. 8.

There may be both NSC and non-NSC traffic where, for example, a user is streaming music to a smartphone attached to a small cell base station and streaming video to a desktop computer connected to a cable modem. Both the small cell and the cable modem are connected to the core network/Internet over the same backhaul (i.e., the user's cable connection) even though the cable modem is not, in this example, a small cell, and as such, both devices are sending/receiving traffic over that same backhaul. Because of the shared backhaul, traffic to/from the small cell (the NSC traffic) can impact the non-NSC traffic to/from the devices connected to the modem.

Referring back to FIG. 9, the cSON module 902 may collect/receive the backhaul capacity and throughput information and RAN measurements reported at 910, as well as status information of the eNBs 904A-C. Although FIG. 9 only illustrates three eNBs 904A-C, the cSON module 902 may collect this backhaul data for the whole network.

At 920, the cSON module 902 may decide to adapt the backhaul uplink Rate Limit at a particular eNB/dSON 904A-C to avoid impacting non-NSC Internet traffic (e.g., uplink ACK packets). The cSON module 902 can break down the composite NSC backhaul uplink Rate Limit into individual NSC Rate Limits, depending on the NSC load, cell size, handoff statistics, etc., and send these values to eNBs/dSONs 904A-C, as appropriate. For example, the cSON module 902 may determine the fraction of the bandwidth of the backhaul that an eNB 904A-C is using and, if the amount of NSC traffic comes within a certain threshold amount of the current Rate Limit, may impose some traffic limitation or perform some load balancing. This effectively limits the aggregate NSC uplink traffic at eNB 904A-C.

At 930, the cSON module 902 notifies the affected eNBs 904A-C of the adapted backhaul uplink Rate Limit, here, eNBs 904A and 904B. At 940, the eNBs 904A and 904B can adjust their uplink Rate Limits accordingly.

Instead of leaving the uplink Rate Limitation Execution solely to the local dSON module, however, at 950, the cSON module 902 can directly provide transmission power range adaptation as in FIG. 7, provide handoff assistance as in FIGS. 8A-B, and/or set the “handoff aggressiveness level” for each eNB as in FIG. 8C. The effect is that an eNB/dSON module can fulfil the new backhaul uplink Rate limit more quickly, and the impact to non-NSC Internet traffic is avoided.

If the X2 interface is available (eNBs use the X2 interface to communicate with each other, most commonly regarding handoffs), neighboring eNBs/cells can exchange resource status update message reports of their respective uplink/downlink backhaul status (e.g., transport network layer (TNL) load). The load in these reports is expressed as the relative values “low,” “mid,” “high,” or “overload.” However, the information exchanged from the backhaul monitoring reports to the cSON module (e.g., the information monitored/reported by the BHM 608A, 608B in FIG. 6A or the BHM 628 in FIG. 6B) is available even when an X2 interface is not present. This information can provide absolute backhaul capacity (in addition to the actual relative load), and can be used to gather a finer level of relative load information (without changes to 3GPP specifications). This additional level of availability and detail can bring significant benefits (i.e., TNL relative load expressed as low, mid, high, or overload).

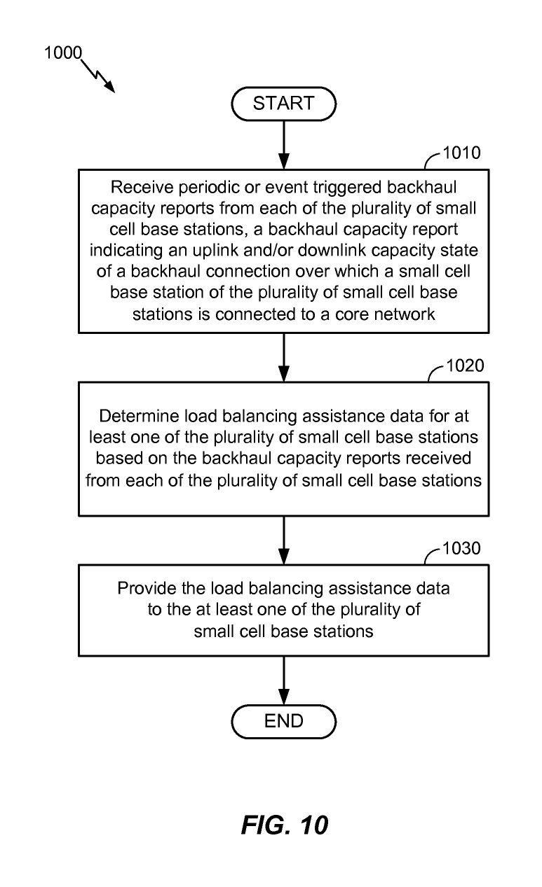

FIG. 10 is a flow diagram illustrating an example method of providing load balancing assistance to a plurality of small cell base stations. The method 1000 may be performed by, for example, the cSON module/server (e.g., cSON module 408 in FIG. 4, cSON server 602 in FIG. 6A, cSON server 620 in FIG. 6B, cSON module 702 in FIG. 7, cSON module 802 in FIGS. 8A-C, or cSON module 902 in FIG. 9).

At 1010, the cSON module/server receives periodic or event triggered backhaul capacity reports from each of the plurality of small cell base stations, as described above with reference to 720 of FIG. 7, for example. The plurality of small cell base stations may be any small cell base stations, such as small cell base stations 110B, 110C in FIG. 1, small cell base station 220 in FIG. 2, small cell base station 300 in FIG. 3, small cell base station 522 in FIG. 5, eNBs 606A, 606B in FIG. 6A, eNBs 626A-C in FIG. 6B, eNBs 704A-C in FIG. 7, eNB 804 in FIGS. 8A-C, and/or eNBs 904A-C in FIG. 9.

A backhaul capacity report may indicate an uplink and/or downlink capacity state of the backhaul connection over which a small cell base station of the plurality of small cell base stations is connected to a core network, such as backhaul link 210 and mobile operator core network/server 216 in FIG. 2. The capacity state may indicate at least one of a measure, estimate, or indication of backhaul throughput capacity, available bandwidth, bulk transfer capacity, latency, loss, or jitter. The capacity state may alternatively or additionally indicate at least one of traffic throughput, available bandwidth, latency, loss, jitter, number of user devices, or number of flows. An event that triggers a backhaul capacity report may include a change in at least one parameter of the backhaul capacity report.

At 1020, the cSON module/server determines load balancing assistance data for at least one of the plurality of small cell base stations based on the periodic or event-triggered backhaul capacity reports received from each of the plurality of small cell base stations. In an aspect, the load balancing assistance data may be an adaptation of a transmission power range of the at least one small cell base station, as discussed above with reference to 730 of FIG. 7. In another aspect, the load balancing assistance data may be an adaptation of a transmission power range of the at least one small cell base station and an adaptation of a transmission power range of another small cell base station of the plurality of base stations, as also discussed above with reference to 730 of FIG. 7. In that case, the adaptation of the transmission power range of the at least one small cell base station may be a reduction of the transmission power range of the at least one small cell base station, and the adaptation of the transmission power range of the other small cell base station may be an increase of the transmission power range of the other small cell base station, or vice versa.

Alternatively, or additionally, the load balancing assistance data may be backhaul capacity data and backhaul traffic data of the plurality of small cell base stations, as discussed above with reference to 850A of FIG. 8A. As another alternative, determining the load balancing assistance data may include determining at least one user device to handoff to another small cell base station of the plurality of small cell base stations based on: 1) the periodic or event-triggered backhaul capacity reports and 2) a list of one or more user devices that have more data in respective data buffers than the one or more user devices are able to transmit at a current bandwidth of the backhaul connection, as discussed above with reference to 850B of FIG. 8B. As yet another alternative, determining the load balancing assistance data may include determining a handoff aggressiveness level for each of the plurality of small cell base stations, as discussed above with reference to 820C of FIG. 8C. Alternatively, the load balancing assistance data may be an adaption of a backhaul uplink rate limit of the at least one small cell base station, as discussed above with reference to 920 of FIG. 9.

At 1030, the cSON module/server provides the load balancing assistance data to the at least one of the plurality of small cell base stations, as at 740 of FIG. 7, 850A of FIG. 8A, 860B of FIG. 8B, and/or 830C of FIG. 8C. The at least one small cell base station may adapt its transmission power range, hand off at least one user device of the one or more user devices to another small cell base station of the plurality of small cell base stations, etc., as directed by the load balancing assistance data.

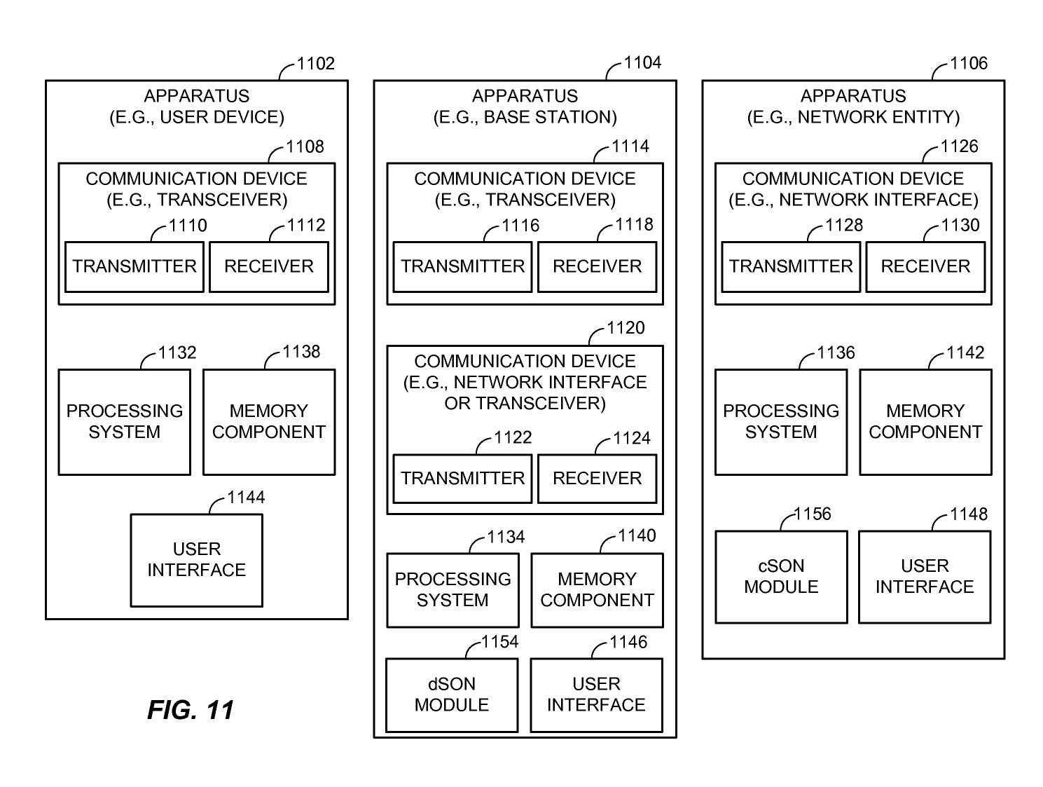

FIG. 11 illustrates several sample components (represented by corresponding blocks) that may be incorporated into an apparatus 1102, an apparatus 1104, and an apparatus 1106 to support the operations of a cSON module/server providing load balancing assistance to a plurality of small cell base stations as taught herein. The apparatus 1102 may correspond to a user device, such as any of user devices 120A-C in FIG. 1, either of user devices 222 in FIG. 2, and/or UEs 806A, 806B in FIGS. 8A-C. The apparatus 1104 may correspond to a base station, such as any of base stations 110A-C in FIG. 1, small cell base station 220 in FIG. 2, small cell base station 300 in FIG. 3, any of base stations 522-532 in FIG. 5, either of eNBs 606A, 606B in FIG. 6, any of eNBs 704A-C in FIG. 7, eNB 804 in FIGS. 8A-C, and/or any of eNBs 904A-C in FIG. 9. Apparatus 1106 may correspond to a network entity having a cSON module/functionality as described herein, such as mobile operator core network/server 216 in FIG. 2, server 400 in FIG. 4, any of servers 502, 506A, 506B, EPC 512, GW 514, CN/EMS/ACS 516 in FIG. 5, cSON server 602, OSS_A 604A, OSS_B 604B in FIG. 6A, or cSON server 620 in FIG. 6B. It will be appreciated that these components may be implemented in different types of apparatuses in different implementations (e.g., in an ASIC, in an SoC, etc.). The illustrated components may also be incorporated into other apparatuses in a communication system. For example, other apparatuses in a system may include components similar to those described to provide similar functionality. Also, a given apparatus may contain one or more of the components. For example, an apparatus may include multiple transceiver components that enable the apparatus to operate on multiple carriers and/or communicate via different technologies.

The apparatus 1102 and the apparatus 1104 each include at least one wireless communication device (represented by the communication devices 1108 and 1114 (and the communication device 1120 if the apparatus 1104 is a relay)) for communicating with other nodes via at least one designated RAT. Each communication device 1108 includes at least one transmitter (represented by the transmitter 1110) for transmitting and encoding signals (e.g., messages, indications, information, and so on) and at least one receiver (represented by the receiver 1112) for receiving and decoding signals (e.g., messages, indications, information, pilots, and so on). Similarly, each communication device 1114 includes at least one transmitter (represented by the transmitter 1116) for transmitting signals (e.g., messages, indications, information, pilots, and so on) and at least one receiver (represented by the receiver 1118) for receiving signals (e.g., messages, indications, information, and so on). If the apparatus 1104 is a relay station, each communication device 1120 may include at least one transmitter (represented by the transmitter 1122) for transmitting signals (e.g., messages, indications, information, pilots, and so on) and at least one receiver (represented by the receiver 1124) for receiving signals (e.g., messages, indications, information, and so on).

A transmitter and a receiver may comprise an integrated device (e.g., embodied as a transmitter circuit and a receiver circuit of a single communication device) in some implementations, may comprise a separate transmitter device and a separate receiver device in some implementations, or may be embodied in other ways in other implementations. A wireless communication device (e.g., one of multiple wireless communication devices) of the apparatus 1104 may also comprise a Network Listen Module (NLM) or the like for performing various measurements.

The apparatus 1106 (and the apparatus 1104 if it is not a relay station) includes at least one communication device (represented by the communication device 1126 and, optionally, 1120) for communicating with other nodes. For example, the communication device 1126 may comprise a network interface that is configured to communicate with one or more network entities via a wire-based or wireless backhaul. In some aspects, the communication device 1126 may be implemented as a transceiver configured to support wire-based or wireless signal communication. This communication may involve, for example, sending and receiving: messages, parameters, or other types of information. Accordingly, in the example of FIG. 11, the communication device 1126 is shown as comprising a transmitter 1128 and a receiver 1130. Similarly, if the apparatus 1104 is not a relay station, the communication device 1120 may comprise a network interface that is configured to communicate with one or more network entities via a wire-based or wireless backhaul. As with the communication device 1126, the communication device 1120 is shown as comprising a transmitter 1122 and a receiver 1124.

The apparatuses 1102, 1104, and 1106 also include other components that may be used in conjunction with the operations for a cSON module/server providing load balancing assistance to a plurality of small cell base stations as taught herein. The apparatus 1102 includes a processing system 1132 for providing functionality relating to, for example, monitoring and reporting uplink/downlink throughput as taught herein and for providing other processing functionality. The apparatus 1104 includes a processing system 1134 and a dSON module 1154, such as dSON module 112 in FIG. 1, for providing functionality relating to, for example, measuring backhaul uplink/downlink capacity periodically or in response to some trigger and reporting it to a cSON module, adapting the transmission power range, determining which UEs to handoff to which neighboring eNB based on load balancing assistance data received from the cSON module, etc., as taught herein and for providing other processing functionality. The apparatus 1106 includes a transmitter 1128, a receiver 1130, and a processing system 1136 and a cSON module 1156, such as cSON module 408 in FIG. 4, for providing functionality relating to, for example, receiving periodic or event-triggered backhaul capacity reports from each of a plurality of small cell base stations, determining load balancing assistance data for at least one of the plurality of small cell base stations based on the periodic or event-triggered backhaul capacity reports, and providing the load balancing assistance data to the at least one of the plurality of small cell base stations as taught herein, and for providing other processing functionality. The apparatuses 1102, 1104, and 1106 include memory components 1138, 1140, and 1142 (e.g., each including a memory device), respectively, for maintaining information (e.g., information indicative of reserved resources, thresholds, parameters, and so on). In addition, the apparatuses 1102, 1104, and 1106 include user interface devices 1144, 1146, and 1148, respectively, for providing indications (e.g., audible and/or visual indications) to a user and/or for receiving user input (e.g., upon user actuation of a sensing device such a keypad, a touch screen, a microphone, and so on).

For convenience, the apparatuses 1102, 1104, and/or 1106 are shown in FIG. 11 as including various components that may be configured according to the various examples described herein. It will be appreciated, however, that the illustrated blocks may have different functionality in different designs.

The components of FIG. 11 may be implemented in various ways. In some implementations, the components of FIG. 11 may be implemented in one or more circuits such as, for example, one or more processors and/or one or more ASICs (which may include one or more processors). Here, each circuit may use and/or incorporate at least one memory component for storing information or executable code used by the circuit to provide this functionality. For example, some or all of the functionality represented by blocks 1108, 1132, 1138, and 1144 may be implemented by processor and memory component(s) of the apparatus 1102 (e.g., by execution of appropriate code and/or by appropriate configuration of processor components). Similarly, some or all of the functionality represented by blocks 1114, 1120, 1134, 1140, and 1146 may be implemented by processor and memory component(s) of the apparatus 1104 (e.g., by execution of appropriate code and/or by appropriate configuration of processor components). Also, some or all of the functionality represented by blocks 1126, 1136, 1142, and 1148 may be implemented by processor and memory component(s) of the apparatus 1106 (e.g., by execution of appropriate code and/or by appropriate configuration of processor components).

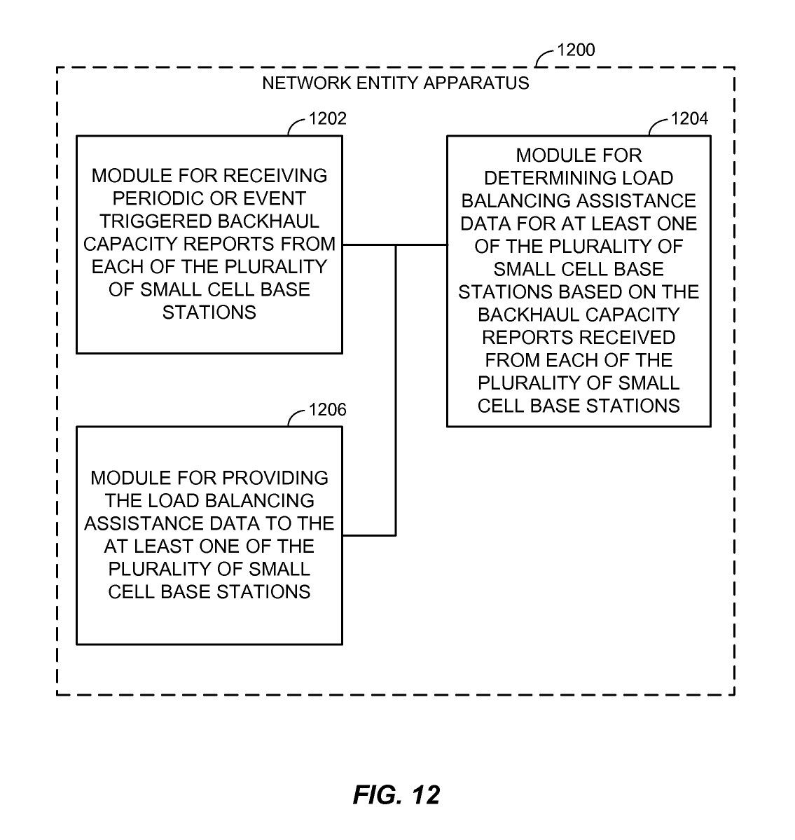

FIG. 12 illustrates an example network entity apparatus 1200, which may correspond to any network entity having the cSON module/functionality described herein, such as mobile operator core network/server 216 in FIG. 2, server 400 in FIG. 4, any of servers 502, 506A, 506B, EPC 512, GW 514, CN/EMS/ACS 516 in FIG. 5, cSON server 602, OSS_A 604A, or OSS_B 604B in FIG. 6A, or cSON server 620 in FIG. 6B. FIG. 12 illustrates the network entity apparatus 1200 represented as a series of interrelated functional modules. A module for receiving 1202 may correspond at least in some aspects to, for example, a communication device, such as network access ports 404 in FIG. 4, and/or a processing system, such as processor 401 in conjunction with cSON module 408 in FIG. 4, as discussed herein. A module for determining 1204 may correspond at least in some aspects to, for example, a processing system, such as processor 401 in conjunction with cSON module 408 in FIG. 4, as discussed herein. A module for providing 1206 may correspond at least in some aspects to, for example, a communication device, such as network access ports 404 in FIG. 4, and/or a processing system, such as processor 401 in conjunction with cSON module 408 in FIG. 4, as discussed herein.

The functionality of the modules of FIG. 12 may be implemented in various ways consistent with the teachings herein. In some designs, the functionality of these modules may be implemented as one or more electrical components. In some designs, the functionality of these blocks may be implemented as a processing system including one or more processor components. In some designs, the functionality of these modules may be implemented using, for example, at least a portion of one or more integrated circuits (e.g., an ASIC). As discussed herein, an integrated circuit may include a processor, software, other related components, or some combination thereof. Thus, the functionality of different modules may be implemented, for example, as different subsets of an integrated circuit, as different subsets of a set of software modules, or a combination thereof. Also, it will be appreciated that a given subset (e.g., of an integrated circuit and/or of a set of software modules) may provide at least a portion of the functionality for more than one module.

In addition, the components and functions represented by FIG. 12, as well as other components and functions described herein, may be implemented using any suitable means. Such means also may be implemented, at least in part, using corresponding structure as taught herein. For example, the components described above in conjunction with the “module for” components of FIG. 12 also may correspond to similarly designated “means for” functionality. Thus, in some aspects one or more of such means may be implemented using one or more of processor components, integrated circuits, or other suitable structure as taught herein.

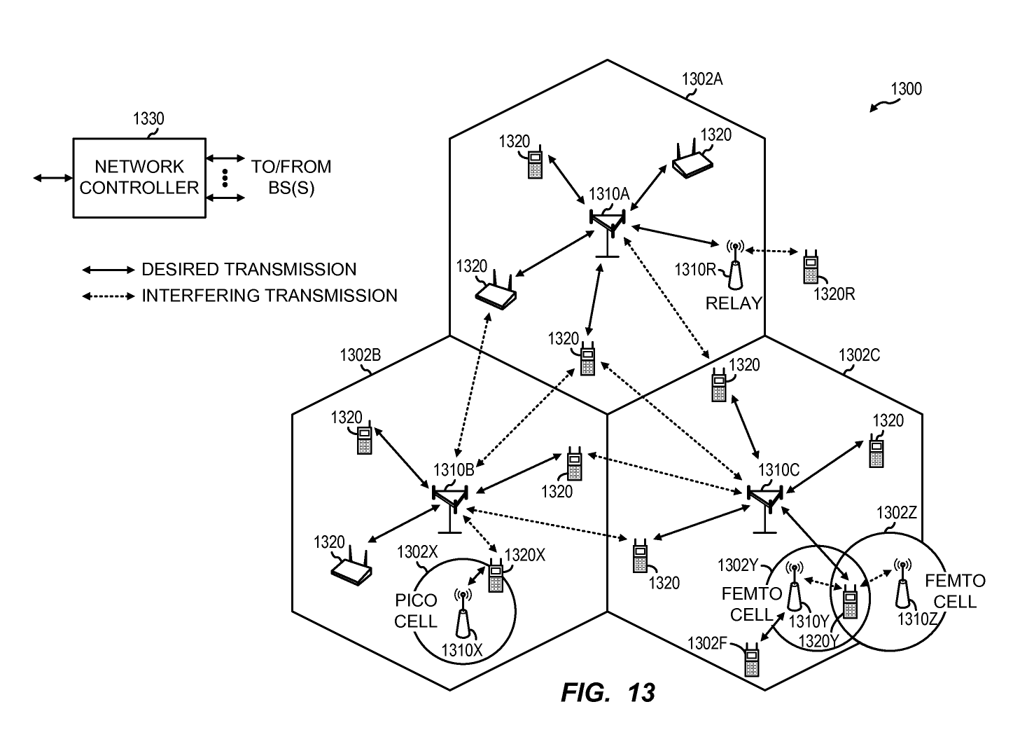

FIG. 13 illustrates an example communication system environment in which the teachings and structures of a cSON module/server providing load balancing assistance to a plurality of small cell base stations described herein may be incorporated. The wireless communication system 1300, which will be described at least in part as an LTE network for illustration purposes, includes a number of eNBs 1310 and other network entities. Each of the eNBs 1310 provides communication coverage for a particular geographic area, such as macro cell or small cell coverage areas.

In the illustrated example, the eNBs 1310A, 1310B, and 1310C are macro cell eNBs for the macro cells 1302A, 1302B, and 1302C, respectively. The macro cells 1302A, 1302B, and 1302C may cover a relatively large geographic area (e.g., several kilometers in radius) and may allow unrestricted access by UEs with service subscription. The eNB 1310X is a particular small cell eNB referred to as a pico cell eNB for the pico cell 1302X. The pico cell 1302X may cover a relatively small geographic area and may allow unrestricted access by UEs with service subscription. The eNBs 1310Y and 1310Z are particular small cells referred to as femto cell eNBs for the femto cells 1302Y and 1302Z, respectively. The femto cells 1302Y and 1302Z may cover a relatively small geographic area (e.g., a home) and may allow unrestricted access by UEs 1302F and 1320Y (e.g., when operated in an open access mode) or restricted access by UEs 1302F and 1320Y having association with the femto cell (e.g., UEs in a Closed Subscriber Group (CSG), UEs for users in the home, etc.), as discussed in more detail below.

The wireless communication system 1300 also includes a relay station 1310R. A relay station is a station that receives a transmission of data and/or other information from an upstream station (e.g., an eNB or a UE) and sends a transmission of the data and/or other information to a downstream station (e.g., a UE or an eNB). A relay station may also be a UE that relays transmissions for other UEs (e.g., a mobile hotspot). In the example shown in FIG. 13, the relay station 1310R communicates with the eNB 1310A and a UE 1320R in order to facilitate communication between the eNB 1310A and the UE 1320R. A relay station may also be referred to as a relay eNB, a relay, etc.

The wireless communication system 1300 is a heterogeneous network in that it includes eNBs of different types, including macro eNBs, pico eNBs, femto eNBs, relays, etc. As discussed in more detail above, these different types of eNBs may have different transmit power levels, different coverage areas, and different impacts on interference in the wireless communication system 1300. For example, macro eNBs may have a relatively high transmit power level whereas pico eNBs, femto eNBs, and relays may have a lower transmit power level (e.g., by a relative margin, such as a 10 dBm difference or more).

Returning to FIG. 13, the wireless communication system 1300 may support synchronous or asynchronous operation. For synchronous operation, the eNBs may have similar frame timing, and transmissions from different eNBs may be approximately aligned in time. For asynchronous operation, the eNBs may have different frame timing, and transmissions from different eNBs may not be aligned in time. Unless otherwise noted, the techniques described herein may be used for both synchronous and asynchronous operation.

A network controller 1330 may couple to a set of eNBs and provide coordination and control for these eNBs. The network controller 1330 may communicate with the eNBs 1310 via a backhaul. The eNBs 1310 may also communicate with one another, e.g., directly or indirectly via a wireless or wireline backhaul.

As shown, the UEs 1320 may be dispersed throughout the wireless communication system 1300, and each UE may be stationary or mobile, corresponding to, for example, a cellular phone, a personal digital assistant (PDA), a wireless modem, a wireless communication device, a handheld device, a laptop computer, a cordless phone, a wireless local loop (WLL) station, or other mobile entities. In FIG. 13, a solid line with double arrows indicates desired transmissions between a UE and a serving eNB, which is an eNB designated to serve the UE on the downlink and/or uplink. A dashed line with double arrows indicates potentially interfering transmissions between a UE and an eNB. For example, UE 1320Y may be in proximity to femto eNBs 1310Y, 1310Z. Uplink transmissions from UE 1320Y may interfere with femto eNBs 1310Y, 1310Z. Uplink transmissions from UE 1320Y may jam femto eNBs 1310Y, 1310Z and degrade the quality of reception of other uplink signals to femto eNBs 1310Y, 1310Z.

Small cell eNBs such as the pico cell eNB 1310X and femto eNBs 1310Y, 1310Z may be configured to support different types of access modes. For example, in an open access mode, a small cell eNB may allow any UE to obtain any type of service via the small cell. In a restricted (or closed) access mode, a small cell may only allow authorized UEs to obtain service via the small cell. For example, a small cell eNB may only allow UEs (e.g., so called home UEs) belonging to a certain subscriber group (e.g., a CSG) to obtain service via the small cell. In a hybrid access mode, alien UEs (e.g., non-home UEs, non-CSG UEs) may be given limited access to the small cell. For example, a macro UE that does not belong to a small cell's CSG may be allowed to access the small cell only if sufficient resources are available for all home UEs currently being served by the small cell.

By way of example, femto eNB 1310Y may be an open-access femto eNB with no restricted associations to UEs. The femto eNB 1310Z may be a higher transmission power eNB initially deployed to provide coverage to an area. Femto eNB 1310Z may be deployed to cover a large service area. Meanwhile, femto eNB 1310Y may be a lower transmission power eNB deployed later than femto eNB 1310Z to provide coverage for a hotspot area (e.g., a sports arena or stadium) for loading traffic from either or both eNB 1310C, eNB 1310Z.

It should be understood that any reference to an element herein using a designation such as “first,” “second,” and so forth does not generally limit the quantity or order of those elements. Rather, these designations may be used herein as a convenient method of distinguishing between two or more elements or instances of an element. Thus, a reference to first and second elements does not mean that only two elements may be employed there or that the first element must precede the second element in some manner. Also, unless stated otherwise a set of elements may comprise one or more elements. In addition, terminology of the form “at least one of A, B, or C” or “one or more of A, B, or C” or “at least one of the group consisting of A, B, and C” used in the description or the claims means “A or B or C or any combination of these elements.” For example, this terminology may include A, or B, or C, or A and B, or A and C, or A and B and C, or 2A, or 2B, or 2C, and so on.

In view of the descriptions and explanations above, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Accordingly, it will be appreciated, for example, that an apparatus or any component of an apparatus may be configured to (or made operable to or adapted to) provide functionality as taught herein. This may be achieved, for example: by manufacturing (e.g., fabricating) the apparatus or component so that it will provide the functionality; by programming the apparatus or component so that it will provide the functionality; or through the use of some other suitable implementation technique. As one example, an integrated circuit may be fabricated to provide the requisite functionality. As another example, an integrated circuit may be fabricated to support the requisite functionality and then configured (e.g., via programming) to provide the requisite functionality. As yet another example, a processor circuit may execute code to provide the requisite functionality.

Moreover, the methods, sequences, and/or algorithms described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor (e.g., cache memory).

Accordingly, it will also be appreciated, for example, that certain aspects of the disclosure can include a computer-readable medium embodying a method for a cSON module/server providing load balancing assistance to a plurality of small cell base stations.

While the foregoing disclosure shows various illustrative aspects, it should be noted that various changes and modifications may be made to the illustrated examples without departing from the scope defined by the appended claims. The present disclosure is not intended to be limited to the specifically illustrated examples alone. For example, unless otherwise noted, the functions, steps, and/or actions of the method claims in accordance with the aspects of the disclosure described herein need not be performed in any particular order. Furthermore, although certain aspects may be described or claimed in the singular, the plural is contemplated unless limitation to the singular is explicitly stated.

What is claimed is:

1. A method of a central self-organizing network (cSON) server providing load balancing assistance to a plurality of small cell base stations, comprising:
receiving periodic or event-triggered backhaul capacity reports from each of the plurality of small cell base stations, a backhaul capacity report indicating an uplink and/or downlink capacity state of a backhaul connection over which a small cell base station of the plurality of small cell base stations is connected to a core network;
determining load balancing assistance data for at least one of the plurality of small cell base stations based on the backhaul capacity reports received from each of the plurality of small cell base stations, wherein the load balancing assistance data comprises an adaption of a backhaul uplink rate limit of the at least one small cell base station; and
providing the load balancing assistance data to the at least one of the plurality of small cell base stations.

2. The method of claim 1, wherein the load balancing assistance data comprises an adaptation of a transmission power range of the at least one small cell base station.

3. The method of claim 1, wherein the load balancing assistance data comprises an adaptation of a transmission power range of the at least one small cell base station and an adaptation of a transmission power range of a second small cell base station of the plurality of small cell base stations.

4. The method of claim 3, wherein the adaptation of the transmission power range of the at least one small cell base station comprises a reduction of the transmission power range of the at least one small cell base station, and wherein the adaptation of the transmission power range of the second small cell base station comprises an increase of the transmission power range of the second small cell base station.

5. The method of claim 1, wherein the uplink and/or downlink capacity state of the backhaul connection indicates at least one of a measure, estimate, or indication of backhaul throughput capacity, available bandwidth, bulk transfer capacity, latency, loss, jitter, or any combination thereof.

6. The method of claim 1, wherein an event that triggers the backhaul capacity report comprises a change in at least one parameter of the backhaul capacity report.

7. The method of claim 1, wherein the uplink and/or downlink capacity state of the backhaul connection indicates at least one of traffic throughput, available bandwidth, latency, loss, jitter, number of user devices, number of flows, or any combination thereof.

8. The method of claim 1, wherein the load balancing assistance data comprises backhaul capacity data and backhaul traffic data of the plurality of small cell base stations.

9. The method of claim 8, wherein the at least one small cell base station determines at least one user device to handoff to another small cell base station of the plurality of small cell base stations based on the backhaul capacity data and the backhaul traffic data of the plurality of small cell base stations.

10. The method of claim 1, further comprising:
receiving a list of one or more user devices that have more data in respective data buffers than the one or more user devices are able to transmit at a current bandwidth of the backhaul connection.

11. The method of claim 10, wherein determining the load balancing assistance data comprises determining at least one user device of the one or more user devices to handoff to another small cell base station of the plurality of small cell base stations based on the periodic or event-triggered backhaul capacity reports and the received list of the one or more user devices.

12. The method of claim 11, wherein the at least one small cell base station hands off the at least one user device of the one or more user devices to the other small cell base station of the plurality of small cell base stations.

13. The method of claim 1, wherein determining the load balancing assistance data comprises determining a handoff aggressiveness level for each of the plurality of small cell base stations.

14. The method of claim 13, wherein the at least one small cell base station identifies one or more user devices that have more data in respective data buffers than the one or more user devices are able to transmit at a current bandwidth of the backhaul connection.

15. The method of claim 14, wherein the at least one small cell base station hands off at least one user device of the one or more user devices based on the determined handoff aggressiveness level and the identified one or more user devices.

16. The method of claim 1, wherein determining the load balancing assistance data comprises:
determining a fraction of a current bandwidth of the backhaul connection used by the at least one small cell base station; and
based on the fraction of the current bandwidth of the backhaul connection being greater than a threshold amount of a current uplink Rate Limit of the at least one small cell base station, setting the adaption of the backhaul uplink rate limit.

17. The method of claim 1, wherein the cSON server is a component of one of the plurality of small cell base stations.

18. The method of claim 1, wherein the cSON server is a component of the core network.

19. The method of claim 1, wherein the backhaul connection comprises one of a digital subscriber line (DSL) connection, a cable connection, or a fiber optic connection.

20. An apparatus for a central self-organizing network (cSON) server providing load balancing assistance to a plurality of small cell base stations, comprising:
a transceiver configured to receive periodic or event-triggered backhaul capacity reports from each of the plurality of small cell base stations, a backhaul capacity report indicating an uplink and/or downlink capacity state of a backhaul connection over which a small cell base station of the plurality of small cell base stations is connected to a core network; and
a processor configured to determine load balancing assistance data for at least one of the plurality of small cell base stations based on the backhaul capacity reports received from each of the plurality of small cell base stations, wherein the load balancing assistance data comprises an adaption of a backhaul uplink rate limit of the at least one small cell base station,
wherein the transceiver is further configured to provide the load balancing assistance data to the at least one of the plurality of small cell base stations.

21. The apparatus of claim 20, wherein the load balancing assistance data comprises an adaptation of a transmission power range of the at least one small cell base station.

22. The apparatus of claim 20, wherein the load balancing assistance data comprises an adaptation of a transmission power range of the at least one small cell base station and an adaptation of a transmission power range of a second small cell base station of the plurality of small cell base stations.

23. The apparatus of claim 22, wherein the adaptation of the transmission power range of the at least one small cell base station comprises a reduction of the transmission power range of the at least one small cell base station, and wherein the adaptation of the transmission power range of the second small cell base station comprises an increase of the transmission power range of the second small cell base station.

24. The apparatus of claim 20, wherein the uplink and/or downlink capacity state of the backhaul connection indicates at least one of a measure, estimate, or indication of backhaul throughput capacity, available bandwidth, bulk transfer capacity, latency, loss, or jitter.

25. The apparatus of claim 20, wherein an event that triggers the backhaul capacity report comprises a change in at least one parameter of the backhaul capacity report.

26. The apparatus of claim 20, wherein the uplink and/or downlink capacity state of the backhaul connection indicates at least one of traffic throughput, available bandwidth, latency, loss, jitter, number of user devices, or number of flows.

27. The apparatus of claim 20, wherein the load balancing assistance data comprises backhaul capacity data and backhaul traffic data of the plurality of small cell base stations.

28. The apparatus of claim 27, wherein the at least one small cell base station determines at least one user device to handoff to another small cell base station of the plurality of small cell base stations based on the backhaul capacity data and the backhaul traffic data of the plurality of small cell base stations.

29. The apparatus of claim 20, wherein the transceiver is further configured to receive a list of one or more user devices that have more data in respective data buffers than the one or more user devices are able to transmit at a current bandwidth of the backhaul connection.

30. The apparatus of claim 29, wherein the processor being configured to determine the load balancing assistance data comprises the processor being configured to determine at least one user device of the one or more user devices to handoff to another small cell base station of the plurality of small cell base stations based on the periodic or event-triggered backhaul capacity reports and the received list of the one or more user devices.

31. The apparatus of claim 30, wherein the at least one small cell base station hands off the at least one user device of the one or more user devices to the other small cell base station of the plurality of small cell base stations.

32. The apparatus of claim 20, wherein the processor being configured to determine the load balancing assistance data comprises the processor being configured to determine a handoff aggressiveness level for each of the plurality of small cell base stations.

33. The apparatus of claim 32, wherein the at least one small cell base station identifies one or more user devices that have more data in respective data buffers than the one or more user devices are able to transmit at a current bandwidth of the backhaul connection.

34. The apparatus of claim 33, wherein the at least one small cell base station hands off at least one user device of the one or more user devices based on the determined handoff aggressiveness level and the identified one or more user devices.

35. The apparatus of claim 20, wherein the processor being configured to determine the load balancing assistance data comprises the processor being configured to:
determine a fraction of a current bandwidth of the backhaul connection used by the at least one small cell base station; and
set the adaption of the backhaul uplink rate limit based on the fraction of the current bandwidth of the backhaul connection being greater than a threshold amount of a current uplink Rate Limit of the at least one small cell base station.

36. The apparatus of claim 20, wherein the cSON server is a component of one of the plurality of small cell base stations.

37. The apparatus of claim 20, wherein the cSON server is a component of the core network.

38. The apparatus of claim 20, wherein the backhaul connection comprises one of a digital subscriber line (DSL) connection, a cable connection, or a fiber optic connection.

39. An apparatus for a central self-organizing network (cSON) server providing load balancing assistance to a plurality of small cell base stations, comprising:
means for receiving periodic or event-triggered backhaul capacity reports from each of the plurality of small cell base stations, a backhaul capacity report indicating an uplink and/or downlink capacity state of a backhaul connection over which a small cell base station of the plurality of small cell base stations is connected to a core network;
means for determining load balancing assistance data for at least one of the plurality of small cell base stations based on the backhaul capacity reports received from each of the plurality of small cell base stations, wherein the load balancing assistance data comprises an adaption of a backhaul uplink rate limit of the at least one small cell base station; and
means for providing the load balancing assistance data to the at least one of the plurality of small cell base stations.

40. A non-transitory computer-readable medium of a central self-organizing network (cSON) server providing load balancing assistance to a plurality of small cell base stations, comprising:
at least one instruction to receive periodic or event-triggered backhaul capacity reports from each of the plurality of small cell base stations, a backhaul capacity report indicating an uplink and/or downlink capacity state of a backhaul connection over which a small cell base station of the plurality of small cell base stations is connected to a core network;
at least one instruction to determine load balancing assistance data for at least one of the plurality of small cell base stations based on the backhaul capacity reports received from each of the plurality of small cell base stations, wherein the load balancing assistance data comprises an adaption of a backhaul uplink rate limit of the at least one small cell base station; and
at least one instruction to provide the load balancing assistance data to the at least one of the plurality of small cell base stations.
